(19) United States
(12) Patent Application Publication
(10) Pub. No.: US 2025/0220363 A1
(43) Pub. Date: Jul. 3, 2025

(54) SIGNAL PROCESSING METHOD AND ACOUSTIC SYSTEM

(71) Applicant: SHENZHEN SHOKZ CO., LTD., Shenzhen (CN)

(72) Inventors: Chenyang WU, Shenzhen (CN); Le XIAO, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/082,302

(22) Filed: Mar. 18, 2025

Related U.S. Application Data
(63) Continuation of application No. PCT/CN2023/094375, filed on May 15, 2023.

(51) Int. Cl. H04R 25/00

(52) U.S. Cl. CPC H04R 25/453; H04R 25/505; H04R 25/604; H04R 25/609; H04R 2430/01

(57) ABSTRACT

A signal processing method and an acoustic system are provided. The method comprises: obtaining a first signal and a second signal, where the first signal is obtained by collecting an ambient sound when a first sound sensor in a sound sensor module is operating, and the second signal is obtained by collecting the ambient sound when a second sound sensor in the sound sensor module is operating, the ambient sound at least comprises a target sound output by a speaker module during operation; performing a first target operation on the first signal and the second signal to generate a composite signal, and further performing a second target operation on the composite signal, where the composite signal is a composite signal of a signal in a first frequency band and a signal in a second frequency band.

### RELATED APPLICATIONS

This application is a continuation application of PCT application No. PCT/CN2023/094375, filed on May 15, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

1. This disclosure relates to the field of acoustic technology, particularly to a signal processing method and an acoustic system.

### BACKGROUND

Some acoustic systems comprise both a speaker and a sound sensor. In these systems, the ambient sound collected by the sound sensor may comprise sound emitted from the speaker, which is detrimental to the operation of the acoustic system. For example, in a hearing aid system, the sound sensor collects ambient sound during operation, amplifies the gain of the ambient sound, and then plays it through the speaker to compensate for the wearer's hearing loss. When the sound emitted by the speaker is recaptured by the sound sensor, a closed-loop circuit is formed in the acoustic system, causing the sound emitted by the speaker to be continuously amplified in the loop, leading to acoustic feedback, which results in discomfort for the wearer. Additionally, in a telephone system or a conference system, voice signals from a remote user are played through the local speaker and are then collected by the local sound sensor along with the voice from the local user, and transmitted back to the remote end. As a result, the remote user may experience interference from echo.

### SUMMARY

This disclosure provides a signal processing method and an acoustic system, which can reduce the signal component derived from a speaker module in a composite signal, thereby suppressing howling or eliminating echo.

In a first aspect, this disclosure provides an acoustic system, comprising: a speaker module, configured to receive an input signal and output a target sound during operation; a sound sensor module, comprising at least: a first sound sensor and a second sound sensor, wherein the first sound sensor collects an ambient sound and generates a first signal during operation, the second sound sensor collects the ambient sound and generates a second signal during operation, and the ambient sound comprises at least the target sound; and a signal processing circuit, wherein the signal processing circuit is connected to the sound sensor module and configured to execute during operation: obtaining a first signal, obtaining a second signal, performing a first target operation on the first signal and the second signal to generate a composite signal, wherein the composite signal is a synthesized signal of a signal in a first frequency band and a signal in a second frequency band, the signal in the first frequency band is derived from a sound pickup result signal of the sound sensor module in a target sound pickup state, the target sound pickup state corresponds to a zero sound pickup direction of the sound sensor module pointing toward the speaker module, and performing a second target operation on the composite signal.

In a second aspect, this disclosure provides a signal processing method, comprising: obtaining a first signal, wherein the first signal is obtained by a first sound sensor in a sound sensor module during operation to capture an ambient sound, the ambient sound at least comprises a target sound, and the target sound is a sound output by a speaker module during operation; obtaining a second signal, wherein the second signal is obtained by a second sound sensor in the sound sensor module during operation to capture the ambient sound; performing a first target operation on the first signal and the second signal to generate a composite signal, wherein the composite signal is a synthesized signal of a signal in a first frequency band and a signal in a second frequency band, the signal in the first frequency band is derived from a sound pickup result signal of the sound sensor module in a target sound pickup state, the target sound pickup state corresponds to a zero sound pickup direction of the sound sensor module pointing toward the speaker module; and performing a second target operation on the composite signal.

From the above technical solutions, it can be known that this disclosure provides a signal processing method and an acoustic system, the method comprising: obtaining a first signal and a second signal, where the first signal is obtained by collecting ambient sound when a first sound sensor in a sound sensor module is operating, and the second signal is obtained by collecting sound when a second sound sensor in the sound sensor module is operating, the ambient sound at least including a target sound output by a speaker module when it is operating; performing a first target operation on the first signal and the second signal to generate a composite signal; and performing a second target operation on the composite signal, where the composite signal is a composite signal of a signal in a first frequency band and a signal in a second frequency band, the signal in the first frequency band coming from a sound pickup result signal of the sound sensor module in a target sound pickup state, the target sound pickup state corresponding to a zero sound pickup direction of the sound sensor module pointing toward the speaker module. In the above solution, since the sound pickup result signal is obtained by sound pickup when the zero sound pickup direction of the sound sensor module points to the speaker module, the sound pickup result signal contains no or fewer signal components from the speaker module. Furthermore, since the first frequency band in the composite signal comes from the sound pickup result signal, the signal components from the speaker module in the composite signal are reduced, thereby reducing the pickup of the target sound emitted by the speaker module by the sound sensor module, enabling the above acoustic system to achieve the effect of suppressing howling or eliminating echo.

Other functions of the acoustic system provided by this disclosure and the signal processing method applied to the acoustic system will be partially listed in the following description. The inventive aspects of the acoustic system provided by this disclosure and the signal processing method applied to the acoustic system can be fully explained through practice or use of the methods, devices, and combinations described in the detailed examples below.

### BRIEF DESCRIPTION OF THE DRAWINGS

To more clearly illustrate the technical solutions in the embodiments of this disclosure, the drawings required for the description of the embodiments will be briefly introduced below. Obviously, the drawings described below are merely some exemplary embodiments of this disclosure. For a person of ordinary skill in the art, other drawings can also be obtained based on these drawings without any creative effort.

2. FIG. 1 shows a schematic diagram of a howling scenario provided according to some exemplary embodiments of this disclosure;

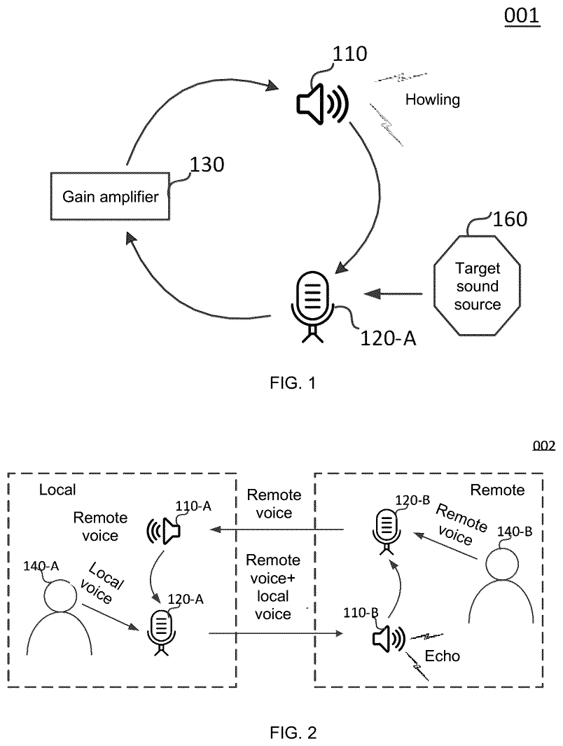

3. FIG. 2 shows a schematic diagram of an echo scenario provided according to some exemplary embodiments of this disclosure;

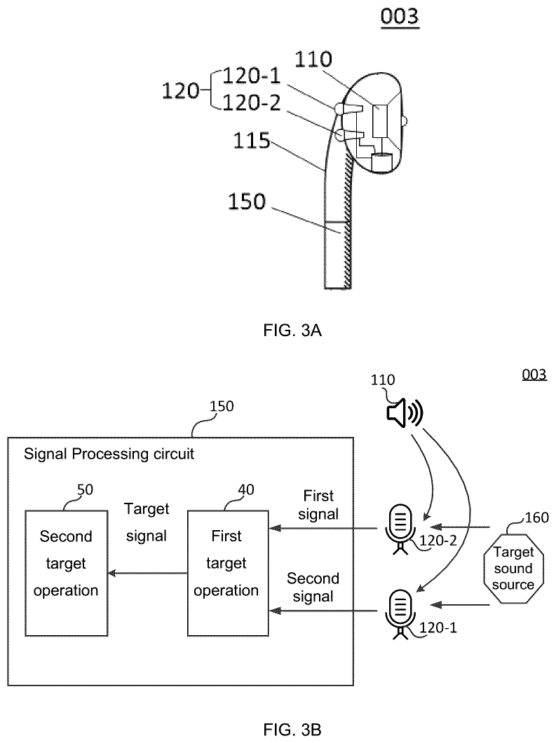

4. FIG. 3A shows a schematic structural diagram of an acoustic system provided according to some exemplary embodiments of this disclosure;

5. FIG. 3B shows a schematic logical diagram of an acoustic system provided according to some exemplary embodiments of this disclosure;

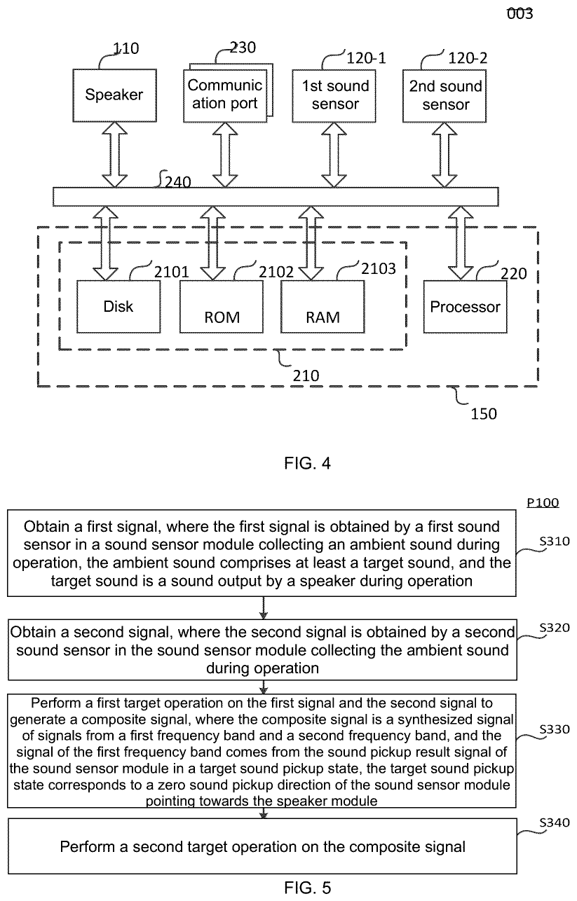

6. FIG. 4 shows a schematic design diagram of the acoustic system shown in FIG. 3A-3B;

7. FIG. 5 shows a flowchart of a signal processing method provided according to some exemplary embodiments of this disclosure;

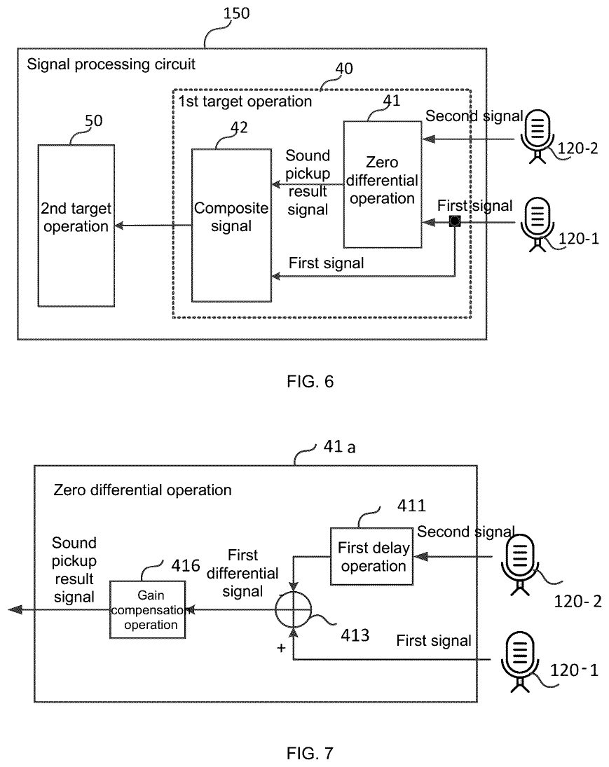

8. FIG. 6 shows a schematic diagram of a signal processing process provided according to some exemplary embodiments of this disclosure;

9. FIG. 7 shows a schematic diagram of a zero differential operation provided according to some exemplary embodiments of this disclosure;

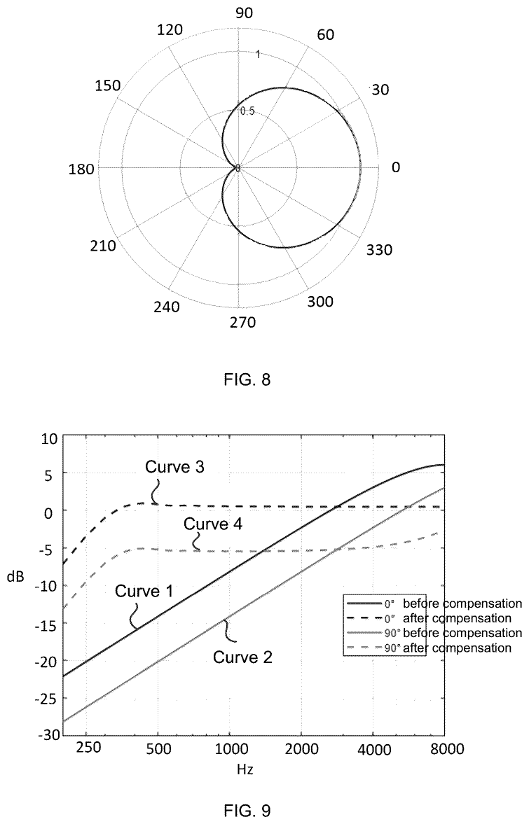

10. FIG. 8 shows a schematic diagram of a sound pickup direction pattern corresponding to the zero differential operation shown in FIG. 7;

11. FIG. 9 shows a schematic diagram of a frequency response curve of a first differential signal obtained using the zero differential operation shown in FIG. 7;

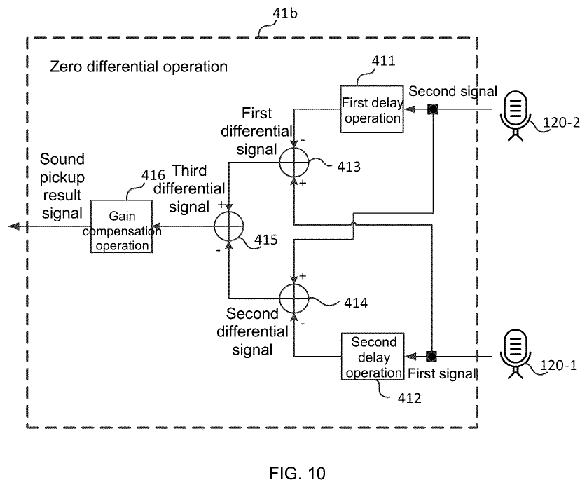

12. FIG. 10 shows a schematic diagram of a zero differential operation provided according to some exemplary embodiments of this disclosure;

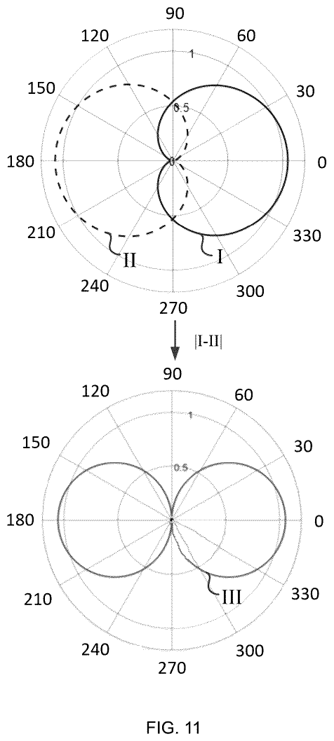

13. FIG. 11 shows a schematic diagram of a principle of sound pickup direction adjustment corresponding to the zero differential operation shown in FIG. 10;

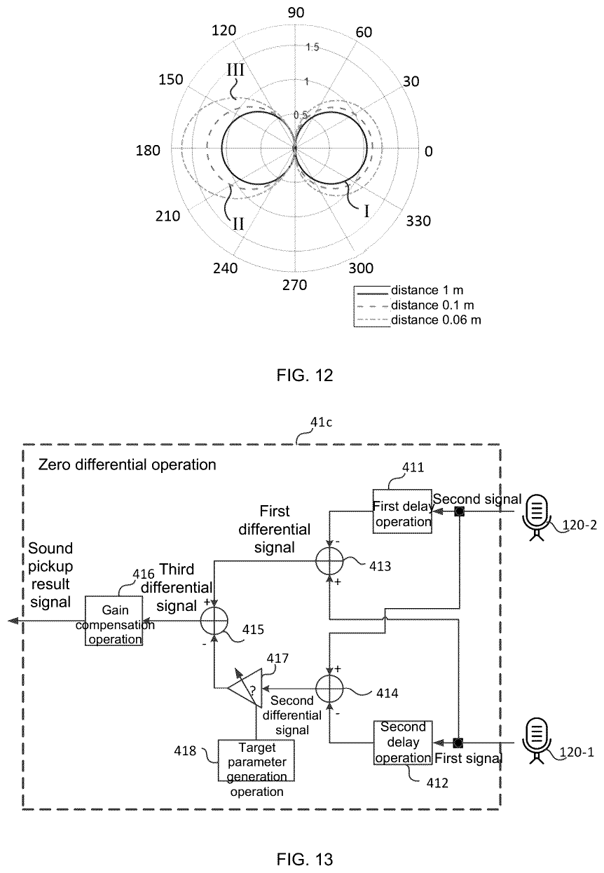

14. FIG. 12 shows a schematic diagram of a sound pickup direction pattern of the zero differential operation shown in FIG. 10 in three different scenarios;

15. FIG. 13 shows a schematic diagram of a zero differential operation provided according to some exemplary embodiments of this disclosure;

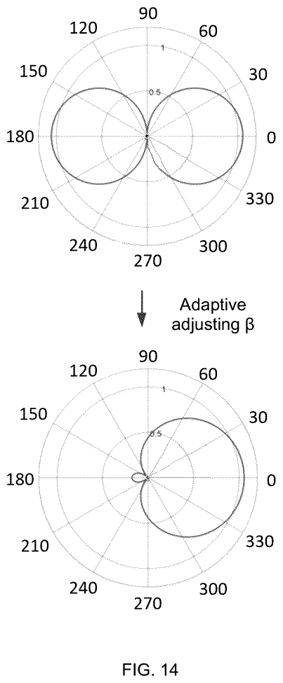

16. FIG. 14 shows a schematic diagram of the adjustment of the zero sound pickup direction by the target parameter β according to some exemplary embodiments of this disclosure;

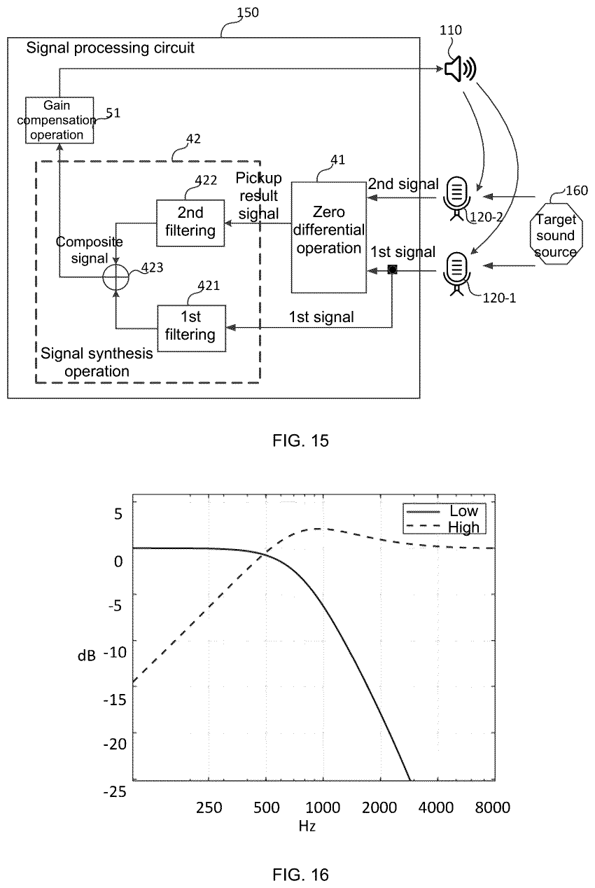

17. FIG. 15 shows a schematic diagram of a signal processing procedure provided according to some exemplary embodiments of this disclosure;

18. FIG. 16 shows a schematic diagram of frequency response curves corresponding to a set of complementary filtering operations provided according to some exemplary embodiments of this disclosure;

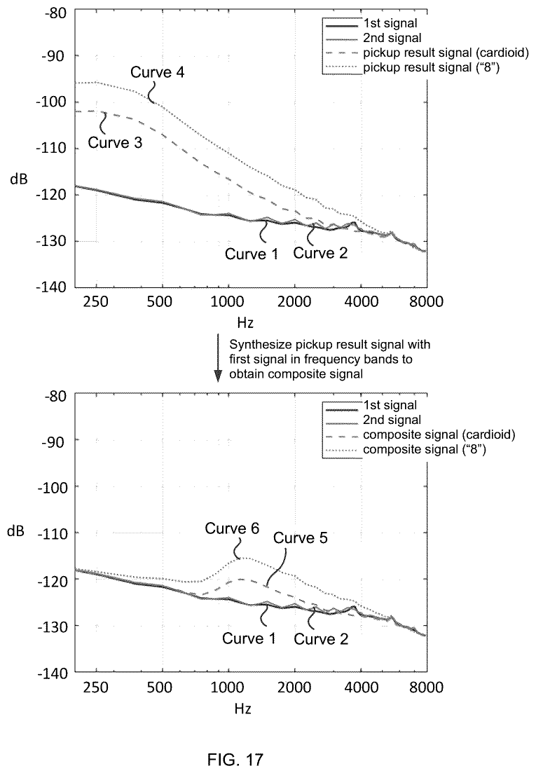

19. FIG. 17 shows a schematic diagram of a background noise components corresponding to the sound pickup result signal and the composite signal in FIG. 15, respectively;

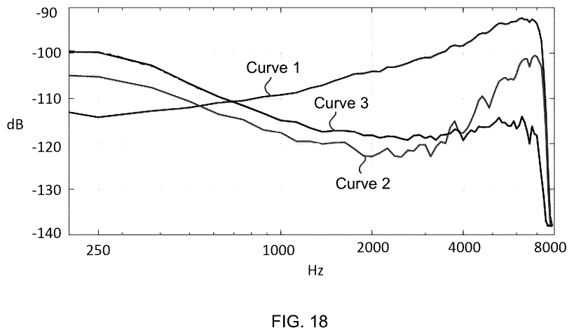

20. FIG. 18 shows a schematic diagram of zero attenuation effects corresponding to different zero differential operations provided according to some exemplary embodiments of this disclosure; and

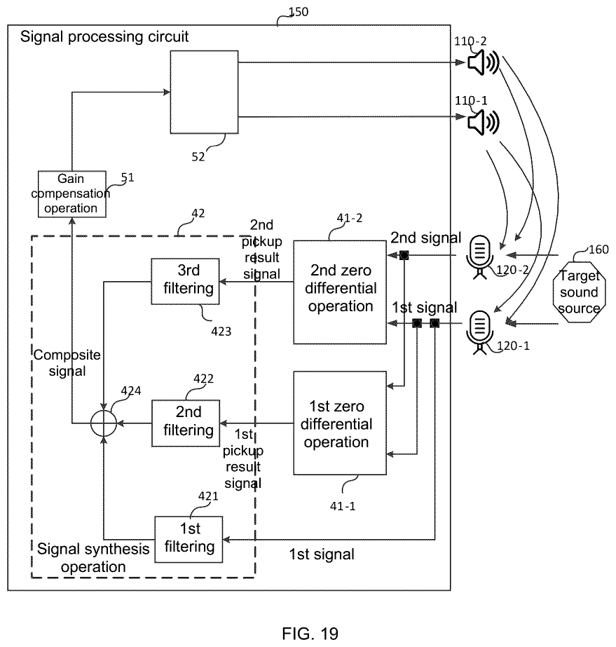

21. FIG. 19 shows a schematic diagram of a signal processing procedure provided according to some exemplary embodiments of this disclosure.

### DETAILED DESCRIPTION

The following description provides specific disclosure scenarios and requirements of this disclosure, with the aim of enabling a person skilled in the art to make and use the content of this disclosure. For a person skilled in the art, various local modifications to the disclosed embodiments will be apparent, and the general principles defined herein may be applied to other embodiments and disclosures without departing from the spirit and scope of this disclosure. Therefore, this disclosure is not limited to the embodiments shown, but rather conforms to the broadest scope consistent with the claims.

The terms used herein are for the purpose of describing specific example embodiments and are not meant to be restrictive. For example, unless otherwise explicitly stated in the context, the singular forms “a,” “an,” and “the” may also include the plural forms. When used in this disclosure, the terms “include,” “comprise,” and/or “contain” mean that the associated integer, step, operation, element, and/or component is present but do not exclude the presence of one or more other features, integers, steps, operations, elements, components, and/or groups, or the possibility of adding other features, integers, steps, operations, elements, components, and/or groups to the system/method.

Given the following description, these features and other features of the disclosure, as well as the operation and functionality of the related elements of the structure, and the combination and manufacturability of the parts, can be significantly improved. The accompanying drawings, which form part of this disclosure, are referenced for illustration. However, it should be clearly understood that the drawings are for illustration and description purposes only and are not intended to limit the scope of this disclosure. It should also be understood that the drawings are not drawn to scale.

The flowcharts used in this disclosure illustrate the operations of the system implementation according to some exemplary embodiments of this disclosure. It should be clearly understood that the operations in the flowcharts may not be implemented in a specific order. Instead, the operations may be performed in reverse order or concurrently. Additionally, one or more other operations may be added to the flowcharts, or one or more operations may be removed from them.

22. For the convenience of description, the terms appearing in this disclosure are first explained below.

23. Howling: Howling is a phenomenon that frequently occurs in acoustic systems. The process of howling generation is explained below with reference to FIG. 1. FIG. 1 shows a schematic diagram of a howling scenario 001 provided according to some exemplary embodiments of this disclosure, where the howling scenario 001 may correspond to scenarios such as a public address system, a hearing aid/assistive listening system, etc. As shown in FIG. 1, the howling scenario 001 comprises a speaker 110-A, a sound sensor 120-A, and a gain amplifier 130. The sound sensor 120-A collects the ambient sound during operation. If the speaker 110-A is also playing sound synchronously during this process, the sound played by the speaker 110-A will also be picked up by the sound sensor 120-A. Thus, the ambient sound collected by the sound sensor 120-A comprises both the sound from the target sound source 160 and the sound from the speaker 110-A. Subsequently, the aforementioned ambient sound is input to the gain amplifier 130 for gain amplification and then played through the speaker 110-A. This forms a closed-loop circuit of “speaker-sound sensor-speaker” in the acoustic system. In this case, when sound signals at certain frequencies undergo self-excited oscillation, the howling phenomenon occurs. Such howling can cause discomfort to users, and when the howling becomes severe, it may even damage the acoustic equipment. Additionally, the presence of howling imposes limitations on the gain amplification factor of the gain amplifier 130, thereby restricting the maximum sound gain that the acoustic system 003 can achieve.

24. Echo: Echo is also a phenomenon that frequently occurs in acoustic systems. The process of echo generation is explained below with reference to FIG. 2. FIG. 2 shows a schematic diagram of an echo scenario 002 provided according to some exemplary embodiments of this disclosure, where the echo scenario 002 may correspond to scenarios such as a telephone system, a conference system, a voice call system, etc. As shown in FIG. 2, the echo scenario 002 comprises a local end and a remote end. The local end comprises a local user 140-A, a speaker 110-A, and a sound sensor 120-A, while the remote end comprises a remote user 140-B, a speaker 110-B, and a sound sensor 120-B. The local end and the remote end can be connected via a network. The network serves as a medium to provide a communication connection between the local end and the remote end, facilitating the exchange of information or data between the two. In some exemplary embodiments, the network can be any type of wired or wireless network, or a combination thereof. For example, the network may comprise a cable network, a wired network, a fiber optic network, a telecommunication network, an intranet, the Internet, a local area network (LAN), a wide area network (WAN), a wireless local area network (WLAN), a metropolitan area network (MAN), a wide area network (WAN), a public switched telephone network (PSTN), a Bluetooth network, a ZigBee network, a near field communication (NFC) network, or similar networks. In some exemplary embodiments, the network may comprise one or more network access points. For example, the network may comprise wired or wireless network access points, such as base stations or Internet exchange points, through which the local end and the remote end can connect to the network to exchange data or information.

25. Continuing with reference to FIG. 2, during the call between the local user 140-A and the remote user 140-B, the remote voice emitted by remote user 140-B is collected by sound sensor 120-B and transmitted to the local end, then played through the local speaker 110-A. The remote voice played by speaker 110-A, along with the local voice emitted by local user 140-A, is collected by the sound sensor 120-A at the local end and then transmitted back to the remote end, where it is played through the remote speaker 110-B. In this way, remote user 140-B will hear his or her own echo, thus being disturbed by the echo. It should be noted that FIG. 2 shows the process in which remote user 140-B is disturbed by the echo. It should be understood that the local user 140-A may also be disturbed by the echo, and the process of echo generation at the local end is similar to the one described above, which will not be elaborated further herein. This kind of echo can interfere with the normal conversation of the users.

26. Background noise: Refers to the surrounding ambient sound other than the sound source being measured. In this disclosure, any sound that is unwanted by the user, undesired by the user, or interferes with the user's hearing can be called noise.

27. Sound pickup direction pattern: Refers to a pattern used to represent the sensitivity of the sound sensor/sound sensor module to sounds from different directions. In simple terms, the sound pickup direction pattern can represent the ability of the sound sensor/sound sensor module to pick up sounds from different directions. Typically, the sound pickup direction pattern can comprise: omnidirectional, heart-shaped, number 8 shaped, super-cardioid-shaped, etc.

28. Zero sound pickup direction: Theoretically, if the sound sensor/sound sensor module has a sensitivity to sound from a certain direction of 0 or close to 0, that direction is referred to as the zero sound pickup direction. It should be understood that when the sound source is located at the zero sound pickup direction, the sound sensor/sound sensor module will theoretically not capture any sound emitted by the sound source. In practice, due to manufacturing errors of the sound sensor/sound sensing module and the fact that sound sources in reality are not necessarily ideal point sources, the sound sensor/sound sensing module may still capture a small amount of sound from the zero sound pickup direction. It should be noted that in this disclosure, the zero sound pickup direction can refer to a specific direction or to a range of directions that comprises multiple directions.

29. Far-field sound source: Refers to a sound source that is relatively far from the sound sensor/sound sensor module. Generally speaking, when the distance between the sound source to be measured and the sound sensor/sound sensor module is greater than N times the physical size of the sound sensor/sound sensor module, the sound source can be approximated as a far-field sound source. It should be noted that in different disclosure scenarios, the value of N can vary. For example, in the case of headphones, the physical size of the sound sensor/sound sensor module may be less than or equal to 0.01 m, and at this time, the value of N can be greater than or equal to 10. This means that a sound source located at a distance greater than or equal to 0.1 m from the sound sensor/sound sensor module can be considered a far-field sound source. Compared to a near-field sound source, the sound waves from the far-field sound source are approximately planar, and the amplitude of the sound waves decreases less as they propagate.

30. Near-field sound source: Refers to a sound source that is relatively close to the sound sensor/sound sensor module. Generally speaking, when the distance between the sound source to be measured and the sound sensor/sound sensor module is less than 2 to 3 times the physical size of the sound sensor/sound sensor module, the sound source can be approximated as a near-field sound source. For example, in the case of headphones, a sound source at a distance less than 0.1 m can be considered a near-field sound source. Compared to the aforementioned far-field sound source, the sound waves from the near-field sound source are closer to spherical, and the amplitude of the sound waves decreases more significantly as they propagate.

31. Before describing the specific embodiments of this disclosure, the disclosure scenarios of this disclosure are introduced as follows: The signal processing method and acoustic system provided in this disclosure can be applied to scenarios that require squeal suppression (such as the scenario shown in FIG. 1) and scenarios that require echo cancellation (such as the scenario shown in FIG. 2). In the aforementioned scenarios, the acoustic system collects ambient sound through the sound sensor module and uses the signal processing method described in this disclosure to process the collected signals to generate a composite signal, so as to reduce the signal components from the speaker in the composite signal, thereby achieving the purposes of squeal suppression or echo cancellation.

32. It should be noted that the squeal suppression scenario and the echo cancellation scenario are just some of the various application scenarios provided in this disclosure. The signal processing method and acoustic system provided in this disclosure can also be applied to other similar scenarios. A person skilled in the art should understand that the signal processing method and acoustic system provided in this disclosure applied to other usage scenarios are also within the scope of protection of this disclosure.

33. FIG. 3A shows a schematic diagram of the structure of an acoustic system 003 according to some exemplary embodiments of this disclosure; FIG. 3B shows a schematic diagram of the logic of the acoustic system 003 according to some exemplary embodiments of this disclosure. The acoustic system 003 can be an amplification system, a hearing/assistive listening system, a telephone system, a conference system, or a voice communication system, etc. The acoustic system 003 can comprise: a speaker module 110, a sound sensor module 120, and a signal processing circuit 150. The sound sensor module 120 comprises at least a first sound sensor 120-1 and a second sound sensor 120-2.

34. It should be noted that in the acoustic system 003 shown in FIG. 3A-3B, the physical positional relationship between the speaker module 110, the first sound sensor 120-1, and the second sound sensor 120-2 can be arbitrary, and the physical positional relationship between the three is not displayed in FIG. 3A-3B. For example, in some exemplary embodiments, the speaker module 110, the first sound sensor 120-1, and the second sound sensor 120-2 can be arranged in a straight line. In another example, in some exemplary embodiments, the speaker module 110 can be located (or approximately located) on the perpendicular bisector of the first sound sensor 120-1 and the second sound sensor 120-2. In this case, the distance between the speaker module 110 and the first sound sensor 120-1 and the distance between the speaker module 110 and the second sound sensor 120-2 are equal (or approximately equal). Of course, the physical positional relationship between the speaker module 110, the first sound sensor 120-1, and the second sound sensor 120-2 can also be other arrangements, which are not individually listed in this disclosure.

35. In some exemplary embodiments, the acoustic system 003 is a hearing system, and the acoustic system 003 may also comprise a housing, with the speaker module 110, the sound sensor module 120, and the signal processing circuit 150 being disposed inside the housing. The housing serves to protect the internal components and makes it convenient for the user to handle and wear. The acoustic system 003 can be worn on the user's head. For example, the acoustic system 003 can be worn in the ear or over the ear at the user's ear region. When the acoustic system 003 is worn on the user's head, the sound-emitting end of the speaker module 110 is oriented towards the user's head, for example, towards the user's ear canal opening or near the ear canal opening. The pickup end of at least one sound sensor in the sound sensor module 120 is located on the side of the housing away from the user's head. In this way, on one hand, it facilitates the pickup of ambient sound, and on the other hand, it can minimize the pickup of sound emitted by the speaker module 110.

36. The first sound sensor 120-1 and the second sound sensor 120-2 can be the same sound sensor or different sound sensors. For ease of description, in this disclosure, the sound sensor in the sound sensor module 120 that is closer to the speaker module 110 is referred to as the second sound sensor 120-2, while the sound sensor farther from the speaker module 110 is referred to as the first sound sensor 120-1. That is to say, the second sound sensor 120-2 is closer to the speaker module 110 compared to the first sound sensor 120-1. In this way, the sound emitted by the speaker module 110 will first be captured by the second sound sensor 120-2 and then by the first sound sensor 120-1. In this case, the phase of the signal component corresponding to the target sound in the second signal is earlier than the phase of the signal component corresponding to the target sound in the first signal. When the distances between the two sound sensors and the speaker module 110 are equal, either one can be referred to as the first sound sensor 120-1, and the other as the second sound sensor 120-2. In this case, the phase of the signal component corresponding to the target sound in the second signal is equal to the phase of the signal component corresponding to the target sound in the first signal. Additionally, the speaker module 110, the first sound sensor 120-1, and the second sound sensor 120-2 can be integrated into the same electronic device or can be independent of each other, and this disclosure does not impose any limitations on this.

37. The speaker module 110 may comprise one speaker or multiple speakers. In the following description, unless otherwise specified, it is illustrated by taking one speaker in the speaker module 110 as an example. When the speaker module 110 comprises multiple speakers, the multiple speakers can be arranged in an array, for example, a linear array, a planar array, a spherical array, or other arrays. Among them, a speaker can also be called an electro-acoustic transducer, which is a device used to convert electrical signals into sound signals. For example, the speaker can be a loud speaker.

38. When operating, the speaker module 110 receives an input signal and converts it into audio for playback. Here, the aforementioned input signal refers to an electrical signal carrying sound information, and the aforementioned audio refers to the sound played through the speaker module 110. In some exemplary embodiments, the input signal received by the speaker module 110 may come from the sound sensor module 120. This situation may correspond to the acoustic scenario shown in FIG. 1. For instance, after the sound sensor module 120 captures ambient sound and generates an electrical signal, it provides the electrical signal to the speaker module 110 for playback, or it preprocesses the electrical signal and then provides it to the speaker module 110 for playback. The aforementioned preprocessing may comprise at least one of amplification processing, noise reduction processing, or enhancement processing. In some exemplary embodiments, the input signal received by the speaker module 110 may also come from other electronic devices. This situation may correspond to the acoustic scenario shown in FIG. 2. For example, the acoustic system 003 can receive an input signal from a remote device, convert the input signal into audio through the speaker module 110 for playback, or preprocess the input signal and then convert it into audio through the speaker module 110 for playback. The aforementioned preprocessing may comprise at least one of amplification processing, noise reduction processing, or enhancement processing.

39. The sound sensor (first sound sensor 120-1 and/or second sound sensor 120-2) can also be referred to as an acoustic-electric transducer or a sound pickup device, which is a device used to capture sound and convert it into an electrical signal. For example, a sound sensor can be a microphone (Microphone, MIC). When operating, the sound sensor captures ambient sound and converts it into an electrical signal carrying sound information. The sound sensor can be an omnidirectional sound sensor, in which case it can capture ambient sound from all directions. The sound sensor can also be a directional sound sensor, in which case it can capture ambient sound from specific directions.

40. Continuing to refer to FIG. 3A-3B, in some exemplary embodiments, the acoustic system 003 can perceive and process sound from a target sound source 160. For example, the target sound source 160 can be an electronic device with sound playback capabilities (such as a television, speaker, mobile phone, etc.), or, for instance, the target sound source 160 can also be a human throat. In this case, the ambient sound comprises both sounds from the target sound source 160 and sound from the speaker module 110. When the first sound sensor 120-1 operates, it captures the ambient sound and generates a first signal, which comprises the sound signal from the target sound source 160 and the sound signal from the speaker module 110. When the second sound sensor 120-2 operates, it captures the ambient sound and generates a second signal, which comprises the sound signal from the target sound source 160 and the sound signal from the speaker module 110. For ease of description, this disclosure refers to the sound emitted by the speaker module 110 as the target sound. Thus, the ambient sound comprises at least the target sound, the first signal comprises at least a signal corresponding to the target sound, and the second signal comprises at least a signal corresponding to the target sound.

41. The signal processing circuit 150 is connected to the sound sensor module 120, as shown in FIG. 3A-3B, with the signal processing circuit 150 being separately connected to the first sound sensor 120-1 and the second sound sensor 120-2. In this way, the signal processing circuit 150 can obtain the first signal from the first sound sensor 120-1 and the second signal from the second sound sensor 120-2. Furthermore, the signal processing circuit 150 can perform the first target operation 40 on the first signal and the second signal to generate a composite signal. The composite signal is a synthesized signal of the signals from the first frequency band and the second frequency band, where the signal of the first frequency band comes from the sound pickup result signal of the sound sensor module 120 in the target sound pickup state, and the target sound pickup state corresponds to the zero sound pickup direction of the sound sensor module 120 pointing towards the speaker module 110. It can be understood that since the sound pickup result signal is obtained by the sound sensor module 120 picking up sound when the zero sound pickup direction points towards the speaker module 110, the sound pickup result signal contains no or relatively little signal components from the speaker. Consequently, the first frequency band in the composite signal, which is derived from the sound pickup result signal, can reduce the signal components from the speaker module 110 in the composite signal. In some exemplary embodiments, “reducing the signal components from the speaker module 110 in the composite signal” may refer to reducing the signal components from the speaker module 110 in the composite signal relative to the first signal and/or the second signal. That is to say, the signal components from the speaker module 110 in the composite signal are fewer than the signal components from the speaker module 110 in the first signal, and/or fewer than the signal components from the speaker module 110 in the second signal. In some exemplary embodiments, “reducing the signal components from the speaker module 110 in the composite signal” may refer to lowering the signal strength from the speaker module 110 in the composite signal relative to the first signal and/or the second signal. That is to say, the signal strength from the speaker module 110 in the composite signal is less than the signal strength from the speaker module 110 in the first signal, and/or less than the signal strength from the speaker module 110 in the second signal.

42. Continuing to refer to FIG. 3A-3B, after generating the composite signal, the signal processing circuit 150 can perform a second target operation 50 on the composite signal. In some exemplary embodiments, the second target operation 50 may comprise: performing gain amplification on the composite signal and sending the gain-amplified signal to the speaker module 110, so that the speaker module 110 converts it into sound. The above solution can be applied to the howling suppression scenario as shown in FIG. 1. It should be understood that since the signal processing circuit 150 reduces the pickup of the target sound by the sound sensor module 120, the signal components from the speaker module 110 in the composite signal are reduced (or the signal strength from the speaker module 110 is lowered), disrupting the conditions under which the sound emitted by the speaker module 110 would generate howling in the closed-loop circuit shown in FIG. 1, thereby achieving the effect of suppressing howling.

43. In some exemplary embodiments, when the speaker module 110, the sound sensor module 120, and the signal processing circuit 150 are deployed in a first acoustic device, the first acoustic device can be communicatively connected to a second acoustic device. In this case, the second target operation 50 may comprise: sending the composite signal to the second acoustic device to reduce echo in the second acoustic device. The above solution can be applied to the echo cancellation scenario as shown in FIG. 2. For example, the first acoustic device may be a local device, and the second acoustic device may be a remote device. Since the composite signal sent by the first acoustic device to the second acoustic device has reduced signal components from the speaker module (or reduced signal strength from the speaker module), it is equivalent to eliminating/reducing the sound from the second acoustic device. Therefore, when the second acoustic device receives the composite signal and plays it, the user on the second acoustic device side (i.e., the remote user) will not hear an echo, thereby achieving the effect of echo cancellation.

44. The signal processing circuit 150 can be configured to execute the signal processing method described in this disclosure. In some exemplary embodiments, the signal processing circuit 150 may comprise multiple hardware circuits with interconnection relationships, each hardware circuit comprising one or more electrical components, which, during operation, implement one or more steps of the signal processing method described in this disclosure. These multiple hardware circuits cooperate with each other during operation to realize the signal processing method described in this disclosure. In some exemplary embodiments, the signal processing circuit 150 may comprise hardware equipment with data information processing capabilities and the necessary programs required to drive the operation of this hardware equipment. The hardware equipment executes these programs to implement the signal processing method described in this disclosure. The signal processing method will be described in detail in the following sections.

45. FIG. 4 shows a schematic design diagram of acoustic system 003. As shown in FIG. 4, the signal processing circuit 150 may comprise: at least one storage medium 210 and at least one processor 220. The at least one processor 220 is communicatively connected to the speaker module 110, the first sound sensor 120-1, and the second sound sensor 120-2. It should be noted that, for the purpose of illustration only, the signal processing circuit 150 in this disclosure comprises at least one storage medium 210 and at least one processor 220. A person of ordinary skill in the art can understand that the signal processing circuit 150 may also comprise other hardware circuit structures, which are not limited in this disclosure, as long as they can satisfy the functions mentioned in this disclosure without departing from the spirit of this disclosure.

46. Continuing to refer to FIG. 4, in some exemplary embodiments, the acoustic system 003 may further comprise a communication port 230. The communication port 230 is used for data communication between the acoustic system and the outside world. For example, the communication port 230 can be used for data communication between the acoustic system and other devices/systems. In some exemplary embodiments, the acoustic system 003 may further comprise an internal communication bus 240. The internal communication bus 240 can connect different system components. For example, the speaker module 110, the first sound sensor 120-1, the second sound sensor 120-2, the processor 220, the storage medium 210, and the communication port 230 can all be connected via the internal communication bus 240.

47. The storage medium 210 may comprise a data storage device. The data storage device can be a non-transitory storage medium or a transitory storage medium. For example, the data storage device may comprise one or more of a magnetic disk 2101, a read-only storage medium (ROM) 2102, or a random access storage medium (RAM) 2103. The storage medium 210 also comprises at least one instruction set stored in the data storage device. The instruction set comprises instructions, which are computer program code. The computer program code may comprise programs, routines, objects, components, data structures, procedures, modules, etc., for executing the signal processing method provided in this disclosure.

48. The at least one processor 220 is configured to execute the aforementioned at least one instruction set. When the acoustic system 003 is running, the at least one processor 220 reads the at least one instruction set and, according to the instructions of the at least one instruction set, executes the signal processing method provided in this disclosure. The processor 220 can perform all or part of the steps included in the aforementioned signal processing method. The processor 220 may be in the form of one or more processors. In some exemplary embodiments, the processor 220 may comprise one or more hardware processors, such as a microcontroller, microprocessor, reduced instruction set computer (RISC), application-specific integrated circuit (ASIC), application-specific instruction set processor (ASIP), central processing unit (CPU), graphics processing unit (GPU), physics processing unit (PPU), microcontroller unit, digital signal processor (DSP), field-programmable gate array (FPGA), advanced RISC machine (ARM), programmable logic device (PLD), any circuit or processor capable of executing one or more functions, or any combination thereof. For illustrative purposes only, the acoustic system 003 shown in FIG. 4 exemplifies a case with only one processor 220. However, it should be noted that the acoustic system 003 provided in this disclosure may also comprise multiple processors. Therefore, the operations and/or method steps disclosed in this disclosure may be performed by a single processor or jointly performed by multiple processors. For example, if the processor 220 of the acoustic system in this disclosure performs step A and step B, it should be understood that step A and step B may also be performed jointly or separately by two different processors 220 (e.g., a first processor performs step A, a second processor performs step B, or the first and second processors jointly perform steps A and B).

49. FIG. 5 shows a flowchart of a signal processing method provided according to some exemplary embodiments of this disclosure. The signal processing method P100 described in this disclosure can be applied to the acoustic system 003 as described earlier. Specifically, the signal processing circuit 150 can execute the signal processing method P100. As shown in FIG. 5, the signal processing method P100 may comprise:

50. S310: Obtain a first signal, where the first signal is obtained by a first sound sensor in a sound sensor module collecting an ambient sound during operation, the ambient sound comprises at least a target sound, and the target sound is a sound output by a speaker during operation.

51. S320: Obtain a second signal, where the second signal is obtained by a second sound sensor in the sound sensor module collecting the ambient sound during operation.

52. The signal processing circuit 150 can obtain the first signal from the first sound sensor 120-1 and the second signal from the second sound sensor 120-2. As mentioned earlier, since the ambient sound comprises both the sound emitted by the target sound source 160 and the target sound emitted by the speaker module 110, the first signal and the second signal obtained by the signal processing circuit 150 both contain signal components from the target sound source 160 as well as signal components from the speaker module 110.

53. It should be noted that this disclosure does not impose any restrictions on the execution order of S310 and S320. The order of execution of the two can be interchangeable, or they can also be executed simultaneously.

54. S330: Perform a first target operation on the first signal and the second signal to generate a composite signal, where the composite signal is a synthesized signal of signals from a first frequency band and a second frequency band, and the signal of the first frequency band comes from the sound pickup result signal of the sound sensor module in a target sound pickup state, the target sound pickup state corresponds to a zero sound pickup direction of the sound sensor module pointing towards the speaker module.

55. The signal processing circuit 150 can generate a composite signal by performing a first target operation 40 on the first signal and the second signal. The purpose of the first target operation 40 is to reduce the pickup of the target sound by the sound sensor module 120, thereby reducing the signal components from the speaker module 110 in the composite signal (i.e., reducing the signal components of the target sound in the composite signal). Here, “reducing the pickup of the target sound by the sound sensor module 120” means that, compared to the pickup of the target sound by the sound sensor module 120 without performing the first target operation, the pickup of the target sound by the sound sensor module 120 is reduced when the first target operation is performed.

56. The composite signal is a signal synthesized by frequency bands; specifically, the composite signal can be a synthesized signal of the signals from the first frequency band and the second frequency band. The signal of the first frequency band comes from the sound pickup result signal of the sound sensor module 120 in a target sound pickup state, where the target sound pickup state corresponds to the zero sound pickup direction of the sound sensor module 120 pointing towards the speaker module 110. The signal of the second frequency band may not be derived from the sound pickup result signal but is obtained through other means. In other words, a portion of the frequency band signals in the composite signal comes from the sound pickup result signal, while another portion of the frequency band signals does not come from the sound pickup result signal.

57. It should be noted that the aforementioned “zero sound pickup direction pointing towards the speaker module 110” should be understood as the zero sound pickup direction generally pointing towards the speaker module 110. For example, the zero sound pickup direction may point to the center point of the speaker module 110. As another example, the zero sound pickup direction may point to any point on the sound output surface of the speaker module 110. As yet another example, the zero sound pickup direction may point to a preset area on the sound output surface of the speaker module 110. As a further example, assuming the direction angle corresponding to the center point of the speaker module 110 is θ, the direction angle corresponding to the zero sound pickup direction may fall within the range [θ−Δφ, θ+Δφ].

58. The sound pickup result signal refers to a single-channel signal obtained by merging/superimposing the pickup signals of the first sound sensor 120-1 and the second sound sensor 120-2 when the zero sound pickup direction of the sound sensor module 120 points towards the speaker module 110. It should be understood that when the zero sound pickup direction of the sound sensor module 120 points towards the speaker module 110 (i.e., in the target sound pickup state), the sound emitted by the speaker module 110 is not captured, or is captured to a lesser extent, by the sound sensor module 120. Therefore, the sound pickup result signal does not contain signal components from the speaker module 110, or contains relatively few signal components from the speaker module 110.

59. It can be understood that since the sound pickup result signal does not contain, or contains relatively few, signal components from the speaker module 110, when the first frequency band in the composite signal is derived from the sound pickup result signal, the composite signal also does not contain, or contains relatively few, signal components from the speaker module 110. Consequently, compared to the first signal and the second signal, the composite signal can reduce the signal components from the speaker module 110.

60. In some exemplary embodiments, the signal of the second frequency band may come from the first signal or the second signal. Since both the first signal and the second signal are raw signals collected by the sound sensor, compared to the sound pickup result signal, the first signal and the second signal can more accurately reflect certain characteristics of the real ambient sound (e.g., background noise features). Therefore, when the signal of the second frequency band comes from the first signal or the second signal, the composite signal retains components of the original signal, allowing the composite signal to more accurately reflect the characteristics of the real ambient sound. It can be understood that when the signal of the first frequency band in the composite signal comes from the sound pickup result signal and the signal of the second frequency band comes from the first signal or the second signal, the composite signal both preserves the components of the original signal collected by the sound sensor and reduces the signal components from the speaker module 110. As a result, the composite signal can reduce the signal components from the speaker module 110 while striving to accurately reflect the real ambient sound, thereby improving the accuracy of the composite signal.

61. For ease of description, the following descriptions will take the example where the signal of the second frequency band comes from the first signal. It should be understood that when the signal of the second frequency band comes from the second signal, the implementation is similar, and this will not be elaborated again herein.

62. FIG. 6 illustrates a schematic diagram of a signal processing process provided according to some exemplary embodiments of the present disclosure. As shown in FIG. 6, in some exemplary embodiments, the first target operation 40 may comprise: a zero differential operation 41 and a signal synthesis operation 42. The zero differential operation 41 is configured to perform a zero differential on the first signal and the second signal to adjust the zero sound pickup direction of the sound sensor module 120 to point towards the speaker module 110, thereby obtaining the sound pickup result signal. In this disclosure, “zero differential” refers to a differential operation capable of adjusting the zero sound pickup direction of the sound sensor module 120. The signal synthesis operation 42 is configured to synthesize the components of the first frequency band from the sound pickup result signal with the components of the second frequency band from the first signal, resulting in the composite signal. The signal processing circuit 150 performs the aforementioned zero differential operation 41 and signal synthesis operation 42 on the first signal and the second signal, such that the components of the first frequency band in the generated composite signal come from the sound pickup result signal, and the signal of the second frequency band comes from the first signal.

63. In some exemplary embodiments, the aforementioned zero differential operation 41 and/or signal synthesis operation 42 may be implemented by the processor 220 in the signal processing circuit 150, meaning that the processor 220 executes a set of instructions and performs the zero differential operation 41 and/or signal synthesis operation 42 according to the instructions. In some exemplary embodiments, the signal processing circuit 150 may comprise a zero differential circuit, and the aforementioned zero differential operation 41 may be implemented through this zero differential circuit. In some exemplary embodiments, the signal processing circuit 150 may comprise a signal synthesis circuit, and the aforementioned signal synthesis operation 42 may be implemented through this signal synthesis circuit.

64. Several implementation methods of the zero differential operation 41 are exemplified below in conjunction with FIGS. 7 to 14.

65. FIG. 7 illustrates a schematic diagram of a zero differential operation 41a provided according to some exemplary embodiments of the present disclosure. As shown in FIG. 7, the zero differential operation 41a may comprise: a first delay operation 411 and a first differential operation 413. The first delay operation 411 is configured to delay the second signal to obtain a second delayed signal. The first differential operation 413 is configured to perform a differential operation (e.g., subtracting the second delayed signal from the first signal) on the first signal and the second delayed signal to obtain a first differential signal.

66. The zero differential operation 41a shown in FIG. 7 above can be applied to a scenario where the speaker module 110 is a far-field sound source. In this scenario, the distance between the speaker module 110 and the sound sensor module 120 is relatively large, and it can be assumed that the amplitude and direction of the sound signals collected by the two sound sensors are the same, with only a time difference (i.e., phase difference) between them. In this case, when the second sound sensor 120-2 is closer to the speaker module 110 than the first sound sensor 120-1, the sound emitted by the speaker module 110 is first collected by the second sound sensor 120-2 and then by the first sound sensor 120-1. In other words, the phase of the signal components from the speaker module 110 in the second signal precedes the phase of the signal components from the speaker module 110 in the first signal. Therefore, by performing the aforementioned first delay operation 411 (i.e., delaying the second signal to obtain a second delayed signal), the signal processing circuit 150 can align the phase of the signal components from the speaker module 110 in the second delayed signal with the phase of the signal components from the speaker module 110 in the first signal.

67. In some exemplary embodiments, when performing the first delay operation 411, the signal processing circuit 150 can determine the delay duration T corresponding to the second signal based on the following formula (1):

$$T = d / c \qquad Formula ( 1 )$$

68. Where d is the distance between the first sound sensor 120-1 and the second sound sensor 120-2, and c is the speed of sound.

69. After performing the aforementioned first delay operation 411, since the phase of the signal components from the speaker module 110 in the second delayed signal has been aligned with the phase of the signal components from the speaker module 110 in the first signal, the signal processing circuit 150 can perform the first differential operation 413 (i.e., subtracting the second delayed signal from the first signal). This allows the signal components from the speaker module 110 in the first signal to cancel out the signal components from the speaker module 110 in the second delayed signal, resulting in the first differential signal exhibiting a zero pickup characteristic in the direction of the speaker module 110.

70. FIG. 8 shows a schematic diagram of the sound pickup direction pattern corresponding to the zero differential operation 41a shown in FIG. 7. As shown in FIG. 8, the sound sensor module exhibits a sound pickup zero characteristic in the 180-degree direction. When the speaker module 110 is located in or near the 180-degree direction, the sound sensor module 120 does not collect (or collects very little) sound emitted by the speaker module 110. Accordingly, it can be seen that the zero differential operation 41a shown in FIG. 7 can adjust the sound pickup direction pattern of the sound sensor module 120 to a cardioid shape, with the zero sound pickup direction pointing to the speaker module 110. Therefore, after the signal processing circuit 150 performs the zero differential operation 41a on the first signal and the second signal as shown in FIG. 7, the first differential signal obtained contains no (or contains less) signal components from the speaker module 110.

71. Further, the inventors analyzed and experimented on the zero differential operation 41a shown in FIG. 7 and found that the zero differential operation 41a has an attenuating effect on components of some frequency bands. An example is provided below with reference to FIG. 9. FIG. 9 shows a schematic diagram of the frequency response curves of the first differential signal obtained using the zero differential operation 41a shown in FIG. 7. As shown in FIG. 9, curve 1 represents the frequency response curve of the first differential signal in the 0-degree direction, and curve 2 represents the frequency response curve of the first differential signal in the 90-degree direction. From curve 1 and curve 2, it can be seen that components of the first differential signal in some frequency bands (for example, below 1000 Hz) are attenuated. In other words, the sound sensor module 120 has lower sensitivity to sound signals in these frequency bands.

72. Therefore, in some exemplary embodiments, with continued reference to FIG. 7, the zero differential operation 41a may further comprise a gain compensation operation 416. The gain compensation operation 416 is configured to perform gain compensation on signals in at least partial frequency bands of the first differential signal to obtain a sound pickup result signal. For example, gain compensation may be performed on components of the first differential signal in the attenuated frequency bands (such as those below 1000 Hz), so that the sound sensor module 120 also has higher sensitivity to sound signals in these frequency bands. With continued reference to FIG. 9, curve 3 shows the frequency response curve of the compensated first differential signal (i.e., the sound pickup result signal) in the 0-degree direction, and curve 4 shows the frequency response curve of the compensated first differential signal (i.e., the sound pickup result signal) in the 90-degree direction. Accordingly, the signal processing circuit 150, by performing the gain compensation operation 416 (that is, by applying gain compensation to signals in at least partial frequency bands of the first differential signal), enables the sound sensor module 120 to have higher and more uniform sensitivity to sound signals across the entire frequency band.

73. As previously mentioned, the zero differential operation 41a shown in FIG. 7 is applicable to scenarios where the speaker module 110 is a far-field sound source. During the inventors' research, it was discovered that when the distance between the speaker module 110 and the sound sensor module 120 is relatively short (for example, less than or equal to 0.1 m), the far-field assumption (i.e., the amplitude and direction of the sound signals collected by the two sound sensors are the same, with only a time difference between them) no longer holds. Therefore, in the near-field sound source scenario, if the zero differential operation 41a shown in FIG. 7 is used to adjust the sound pickup direction, the adjusted sound pickup direction pattern will no longer have a sound pickup zero. To address this, the present disclosure also provides another zero differential operation, which can be applied to both scenarios where the speaker module 110 is a far-field sound source and where the speaker module 110 is a near-field sound source. The explanation is provided below with reference to FIG. 10.

74. FIG. 10 shows a schematic diagram of a zero differential operation 41b provided according to some exemplary embodiments of the present disclosure. As shown in FIG. 10, the zero differential operation 41b may comprise: a first delay operation 411, a second delay operation 412, a first differential operation 413, a second differential operation 414, and a third differential operation 415.

75. The first delay operation 411 is configured to delay the second signal to obtain a second delayed signal. In some exemplary embodiments, the delay duration of the second signal can be determined based on the aforementioned formula (1), which will not be elaborated herein. The second delay operation 412 is configured to delay the first signal to obtain a first delayed signal. In some exemplary embodiments, the delay duration of the first signal can be determined based on the aforementioned formula (1), which will not be elaborated herein. The first differential operation 413 is configured to perform a differential operation between the first signal and the second delayed signal (i.e., subtract the second delayed signal from the first signal) to obtain a first differential signal. The second differential operation 414 is configured to perform a differential operation between the second signal and the first delayed signal (i.e., subtract the first delayed signal from the second signal) to obtain a second differential signal. The third differential operation 415 is configured to perform a differential operation between the first differential signal and the second differential signal (i.e., subtract the second differential signal from the first differential signal) to obtain a third differential signal.

76. It should be understood that the principle of sound pickup direction adjustment for the zero differential operation 41b shown in FIG. 10 is similar to that in FIG. 7. The difference between them lies in the fact that the zero differential operation 41b in FIG. 10 requires two delay operations. Therefore, the scheme shown in FIG. 7 can be referred to as a single-delay zero differential scheme, while the scheme shown in FIG. 10 can be referred to as a double-delay zero differential scheme. FIG. 11 illustrates a schematic diagram of the sound pickup direction adjustment principle corresponding to the zero differential operation 41b shown in FIG. 10. As shown in FIG. 11, the signal processing circuit 150, by performing the first delay operation 411 and the first differential operation 413, can construct a cardioid pattern with the zero sound pickup direction pointing to 180 degrees (see pattern I in FIG. 11). This construction principle is the same as that in FIG. 7 and will not be elaborated herein. Furthermore, the signal processing circuit 150, by performing the second delay operation 412 and the second differential operation 414, can construct a cardioid pattern with the zero sound pickup direction pointing to 0 degrees (see pattern II in FIG. 11). This construction principle is also similar to that in FIG. 7 and will not be detailed herein. It should be understood that the cardioid pattern with the zero sound pickup direction pointing to 180 degrees (i.e., pattern I in FIG. 11) corresponds to the first differential signal, and the cardioid pattern with the zero sound pickup direction pointing to 0 degrees (i.e., pattern II in FIG. 11) corresponds to the second differential signal. By performing the third differential operation 415 (which is equivalent to taking the difference between pattern I and pattern II), the signal processing circuit 150 can obtain a number eight (“8”) pattern with the zero sound pickup direction pointing to 90 degrees and 270 degrees (see pattern III in FIG. 11).

77. From the above-mentioned sound pickup direction pattern in a shape of number “8” (i.e., pattern III), it can be seen that the sound sensor module 120 exhibits a sound pickup zero characteristic in the 90-degree and 270-degree directions. When the speaker module 110 is located in or near the 90-degree/270-degree directions, the sound sensor module 120 does not collect (or collects very little) sound emitted by the speaker module 110. Accordingly, it can be seen that the double-delay-based zero differential operation 41b shown in FIG. 10 can adjust the sound pickup direction pattern of the sound sensor module 120 into a shape of number “8,” with the zero sound pickup direction pointing to the speaker module 110. Therefore, the third differential signal obtained by the signal processing circuit 150 through performing the zero differential operation 41b contains no (or contains fewer) signal components from the speaker module 110.

78. FIG. 12 shows schematic diagrams of the sound pickup direction patterns of the zero differential operation 41b shown in FIG. 10 under three different scenarios. As shown in FIG. 12: Pattern I illustrates the sound pickup direction pattern obtained when the distance between the speaker module 110 and the sound sensor module 120 is 1 m. Pattern II illustrates the sound pickup direction pattern obtained when the distance between the speaker module 110 and the sound sensor module 120 is 0.1 m. Pattern III illustrates the sound pickup direction pattern obtained when the distance between the speaker module 110 and the sound sensor module 120 is 0.06 m. From FIG. 12, it can be seen that regardless of the distance between the speaker module 110 and the sound sensor module 120, the zero differential operation 41b shown in FIG. 10 can always produce a sound pickup direction pattern in a shape of number “8.” Therefore, the zero differential operation 41b shown in FIG. 10 can be applied to both scenarios where the speaker module 110 is a near-field sound source and where the speaker module 110 is a far-field sound source. As a result, the zero differential operation 41b shown in FIG. 10 can effectively reduce the signal components from the speaker module 110 in the third differential signal in all scenarios.

79. Furthermore, referring again to FIG. 10, the zero differential operation 41b may also comprise a gain compensation operation 416. The gain compensation operation 416 is configured to perform gain compensation on the signal of at least a partial frequency band in the third differential signal to obtain the sound pickup result signal. It should be understood that the principle and function of the gain compensation operation 416 in FIG. 10 are the same as those of the gain compensation operation 416 in FIG. 7, and thus will not be elaborated herein.

80. In the case of using the zero differential operation 41b shown in FIG. 10, the zero sound pickup direction of the sound sensor module 120 points to 90 degrees and 270 degrees, meaning that all positions on the perpendicular bisector of the first sound sensor 120-1 and the second sound sensor 120-2 are located in the zero sound pickup direction of the sound sensor module 120. Therefore, during product design, the speaker module 110 can be placed on the perpendicular bisector of the first sound sensor 120-1 and the second sound sensor 120-2, so that the sound pickup result signal of the sound sensor module 120 does not contain signal components from the speaker module 110. However, in practical applications, due to various factors such as product form, manufacturing tolerances, and wearing posture, the speaker module 110 usually cannot be strictly located on the perpendicular bisector of the first sound sensor 120-1 and the second sound sensor 120-2. As a result, the signal components from the speaker module 110 in the sound pickup result signal of the sound sensor module 120 are reduced compared to the sound pickup result signal without zero differential operation, but still comprise signal components from the speaker module 110. To address this, the present disclosure further provides a zero differential operation capable of adaptively adjusting the zero sound pickup direction, so as to minimize the signal components from the speaker module 110 in the sound pickup result signal. The following description will be provided with reference to FIG. 13.

81. FIG. 13 shows a schematic diagram of a zero differential operation 41c provided according to some exemplary embodiments of the present disclosure. As shown in FIG. 13, based on the zero differential operation 41b shown in FIG. 10, the zero differential operation 41c may further comprise a multiplication operation 417 and a target parameter generation operation 418. The target parameter generation operation 418 is configured to generate a target parameter β with the goal of minimizing the signal components from the speaker module 110 in the third differential signal. The multiplication operation 417 is executed between the second differential operation 414 and the third differential operation 415, or between the first differential operation 413 and the third differential operation 415. For ease of description, the following explanation and the accompanying drawings take “the multiplication operation 417 being executed between the second differential operation 414 and the third differential operation 415” as an example. Specifically, the multiplication operation 417 is configured to multiply the target parameter β with the second differential signal to obtain a multiplication result, so that the third differential operation 415 performs a differential operation on the first differential signal and the multiplication result to obtain the third differential signal.

82. It should be understood that the second differential signal corresponds to pattern II in FIG. 11 (i.e., the zero sound pickup direction points to the 0-degree heart-shaped pattern). By multiplying the target parameter β with the second differential signal, the second differential signal is adjusted. Furthermore, by performing the third differential operation 415 based on the first differential signal and the adjusted second differential signal, the zero sound pickup direction can be adjusted from 90 degrees/270 degrees to other angles. FIG. 14 shows a schematic diagram of the adjustment of the zero sound pickup direction based on the target parameter β, according to some exemplary embodiments of the present disclosure. As shown in FIG. 14, when the target parameter β is 0.99, the zero points in the sound pickup direction pattern point to 90 degrees and 270 degrees. When the target parameter β is updated to 0.16, the zero in the sound pickup direction pattern points to 135 degrees and 225 degrees. Thus, the signal processing circuit 150, by performing the multiplication operation 417 and the target parameter generation operation 418, can adaptively adjust the zero sound pickup direction, minimizing the signal components from the speaker module 110 in the sound pickup result signal.

83. It should be noted that the various zero differential operations 41 involved in this disclosure (e.g., zero differential operation 41a shown in FIG. 7, zero differential operation 41b shown in FIG. 10, and zero differential operation 41c shown in FIG. 13) can be performed in the time domain or the frequency domain, and the application is not limited to either.

84. In some exemplary embodiments, any one or more of the aforementioned first delay operation 411, second delay operation 412, first differential operation 413, second differential operation 414, third differential operation 415, gain compensation operation 416, multiplication operation 417, and target parameter generation operation 418 may be implemented by the processor 220 in the signal processing circuit 150. That is, the processor 220 executes an instruction set and performs one or more of the above operations according to the instructions in the set. In some exemplary embodiments, the signal processing circuit 150 may comprise a first delay circuit, and the aforementioned first delay operation 411 may be implemented by the first delay circuit. In some exemplary embodiments, the signal processing circuit 150 may comprise a second delay circuit, and the aforementioned second delay operation 412 may be implemented by the second delay circuit. In some exemplary embodiments, the signal processing circuit 150 may comprise a first differential circuit, and the aforementioned first differential operation 413 may be implemented by the first differential circuit. In some exemplary embodiments, the signal processing circuit 150 may comprise a second differential circuit, and the aforementioned second differential operation 414 may be implemented by the second differential circuit. In some exemplary embodiments, the signal processing circuit 150 may comprise a third differential circuit, and the aforementioned third differential operation 415 may be implemented by the third differential circuit. In some exemplary embodiments, the signal processing circuit 150 may comprise a gain compensation circuit, and the aforementioned gain compensation operation 416 may be implemented by the gain compensation circuit. In some exemplary embodiments, the signal processing circuit 150 may comprise a multiplication circuit, and the aforementioned multiplication operation 417 may be implemented by the multiplication circuit. In some exemplary embodiments, the signal processing circuit 150 may comprise a target parameter generation circuit, and the aforementioned target parameter generation operation 418 may be implemented by the target parameter generation circuit.

85. As described earlier, the zero differential operation 41 (such as zero differential operation 41a shown in FIG. 7, zero differential operation 41b shown in FIG. 10, and zero differential operation 41c shown in FIG. 13) will comprise the gain compensation operation 416. However, the gain compensation operation 416 inevitably causes certain frequency band components of the background noise in the sound pickup result signal to be elevated. When the background noise is elevated to a certain sound intensity, it can affect the user's auditory experience.

86. Therefore, in some exemplary embodiments, the second frequency band may comprise the frequency band corresponding to the background noise of the current environment, while the first frequency band comprises all frequency bands except the second frequency band. This way, when the composite signal has components from the second frequency band (i.e., the frequency band corresponding to the background noise) from the first signal, and the components from the first frequency band (i.e., the frequency band excluding the background noise) from the sound pickup result signal, the first signal, which has not undergone zero differential operation 41, can accurately reflect the background noise features of the current environment. Thus, the problem of elevating the background noise components is avoided.

87. In some exemplary embodiments, the signal processing method P100 may also comprise: determining the background noise feature of the current environment based on the first and second signals, and then determining the frequency range corresponding to the first frequency band and the frequency range corresponding to the second frequency band based on the background noise feature. For example, the background noise feature may comprise the frequency band corresponding to the background noise, or it may comprise other characteristics that indicate the frequency band of the background noise. In this way, the signal processing circuit 150, based on the background noise feature, can identify the frequency band corresponding to the background noise and then define this frequency band as the second frequency band, with the remaining frequency bands being defined as the first frequency band. In this approach, the signal processing circuit 150 can adaptively adjust the frequency ranges of the first and second frequency bands based on the current environment's background noise feature, thus reducing the signal components from the speaker module 110 in the composite signal without elevating the background noise in any scenario.

88. In practical applications, considering that the background noise in the environment is typically low-frequency noise, in some exemplary embodiments, the frequency in the first frequency band may be higher than the frequency in the second frequency band. For example, the first frequency band could be a high-frequency band, and the second frequency band could be a low-frequency band. Alternatively, the first frequency band could be a mid-to-high frequency band, and the second frequency band could be a low-frequency band. Another example could be that the first frequency band is a high-frequency band, and the second frequency band is a mid-to-low frequency band. Yet another example could be that the first frequency band is a mid-frequency band, and the second frequency band is a low-frequency band, and so on. In other words, the lower frequency range in the sound pickup frequency band of the sound sensor module 120 is designated as the second frequency band, and the components of the second frequency band in the composite signal are derived from the first signal, thereby avoiding the problem of elevating the background noise components.

89. The low-frequency band mentioned above refers to a frequency band generally below 1 kHz, the mid-frequency band refers to a frequency band generally between 1 kHz and 4 kHz, the high-frequency band refers to a frequency band above 4 kHz, the mid-low frequency band refers to a frequency band generally below 4 kHz, and the mid-high frequency band refers to a frequency band generally above 1 kHz. One skilled in the art should understand that the division of these frequency bands is merely given as an example with approximate ranges. The definition of these frequency bands can change depending on different industries, applications, and classification standards. For example, in some application scenarios, the low-frequency band may refer to a frequency band roughly between 20 Hz and 150 Hz, the mid-frequency band may refer to a frequency band roughly between 150 Hz and 5 kHz, the high-frequency band may refer to a frequency band roughly between 5 kHz and 20 KHz, the mid-low frequency band may refer to a frequency band roughly between 150 Hz and 500 Hz, and the mid-high frequency band may refer to a frequency band between 500 Hz and 5 kHz. In other application scenarios, the low-frequency band may refer to a frequency band roughly between 20 Hz and 80 Hz, the mid-low frequency band may refer to a frequency band roughly between 80 Hz and 160 Hz, the mid-frequency band may refer to a frequency band roughly between 160 Hz and 1280 Hz, the mid-high frequency band may refer to a frequency band roughly between 1280 Hz and 2560 Hz, and the high-frequency band may refer to a frequency band roughly between 2560 Hz and 20 KHz.

90. FIG. 15 shows a schematic diagram of a signal processing process according to some exemplary embodiments of the present disclosure, which is used to refine the signal synthesis operation 42 in FIG. 6. It should be understood that the zero differential operation 41 in FIG. 15 can be implemented as zero differential operation 41a as shown in FIG. 7, zero differential operation 41b as shown in FIG. 10, or zero differential operation 41c as shown in FIG. 13. The specific details can be referenced in the relevant sections of the earlier description and will not be elaborated herein.

91. As shown in FIG. 15, the signal synthesis operation 42 can comprise: a first filtering operation 421, a second filtering operation 422, and a synthesis operation 424. The first filtering operation 421 is configured to perform first filtering on the first signal to extract the component corresponding to the second frequency band from the first signal. For example, when the second frequency band is the low-frequency band, the first filtering operation 421 can be realized using a low-pass filter. The second filtering operation 422 is configured to perform second filtering on the sound pickup result signal to extract the component corresponding to the first frequency band from the sound pickup result signal. For example, when the first frequency band is the high-frequency band, the second filtering operation 422 can be realized using a high-pass filter. The synthesis operation 424 is configured to synthesize the component of the second frequency band obtained from the first filtering operation 421 and the component of the first frequency band obtained from the second filtering operation 422 to generate the composite signal. In some exemplary embodiments, the synthesis operation 424 can be realized using an adder.

92. Thus, the signal processing circuit 150 extracts the component corresponding to the second frequency band from the first signal by performing the first filtering operation 421, and extracts the component corresponding to the first frequency band from the sound pickup result signal by performing the second filtering operation 422. Then, by performing the synthesis operation 424, the components of the first and second frequency bands are synthesized to generate the composite signal, such that the first frequency band in the composite signal comes from the sound pickup result signal, and the second frequency band comes from the first signal.

93. In some exemplary embodiments, the first filtering and second filtering can be complementary filters, meaning that the transfer function of the first filtering and the transfer function of the second filtering together equal 1. For example, if the transfer function corresponding to the first filtering is expressed by the following formula (2), the transfer function corresponding to the second filtering can be expressed by the following formula (3).

$$Filter\_ 1 = \frac{B ( z )}{A ( z )} \qquad Formula ( 2 )$$

$$Filter\_ 2 = \frac{A ( z ) - B ( z )}{A ( z )} \qquad Formula ( 3 )$$

94. As can be seen from formula (2) and formula (3), the denominator expressions corresponding to the transfer functions of the two filtering operations are the same, both being A(z). The numerator expressions corresponding to the transfer functions of the two filtering operations are B(z) and A(z)-B(z), respectively. This design ensures that the sum of the transfer functions of the two filtering operations equals 1, thereby presenting an all-pass characteristic when the two filtering operations work together. For ease of understanding, FIG. 16 shows a schematic of the frequency response curves corresponding to a set of complementary filtering operations provided by the embodiment of this disclosure. As shown in FIG. 16, curve 1 corresponds to the frequency response curve of the first filtering operation 421 in FIG. 15, presenting a low-pass characteristic, and curve 2 corresponds to the frequency response curve of the second filtering operation 422 in FIG. 15, presenting a high-pass characteristic. When these two filtering operations are used together, they will present an all-pass characteristic.

95. It should be noted that the complementary filtering operations illustrated in formulas (2) and (3) are merely one possible example. One skilled in the art will understand that any filter group capable of performing frequency division and synthesis is feasible. For instance, in some exemplary embodiments, the above-mentioned first filtering and second filtering can also be implemented using first and second filters with the same cutoff frequency. Specifically, the cutoff frequency of the first filter is w1, the cutoff frequency of the second filter is w2, and the cutoff frequencies of both filters are the same: w1=w2. Additionally, the amplitude responses of both filters at the cutoff frequency may satisfy |Filter_{1(w}_{₁}₎|=|Filter_{2(w}_{₂}₎|=−3 dB.

96. FIG. 17 shows a schematic diagram of the background noise components corresponding to the sound pickup result signal and the composite signal in FIG. 15. As shown in FIG. 17, curve 1 illustrates the background noise component in the first signal collected by the first sound sensor 120-1, and curve 2 illustrates the background noise component in the second signal collected by the second sound sensor 120-1. It can be understood that since the first and second signals are the raw signals collected by the sound sensors, curve 1 and curve 2 can more accurately reflect the background noise situation of the current environment. Curve 3 illustrates the background noise component in the sound pickup result signal obtained by performing the zero differential operation 41a shown in FIG. 7 (corresponding to a heart-shaped sound pickup direction pattern). Curve 4 illustrates the background noise component in the sound pickup result signal obtained by performing the zero differential operation 41b shown in FIG. 10 (corresponding to a number “8” shaped sound pickup direction pattern). From curves 3 and 4, it can be seen that both the zero differential operation 41a shown in FIG. 7 (single-delay zero differential scheme) and the zero differential operation 41b shown in FIG. 10 (dual-delay zero differential scheme) will cause a significant increase in the background noise of the low frequency band (i.e., the second frequency band), thereby causing a greater noise disturbance to the user.

97. Continuing with reference to FIG. 17, curve 5 shows the background noise component in the composite signal obtained by performing the zero differential operation 41a (corresponding to the heart-shaped sound pickup direction pattern) and frequency band synthesis of the first signal. Curve 6 shows the background noise component in the composite signal obtained by performing the zero differential operation 41b (corresponding to the number “8” shaped sound pickup direction pattern) and frequency band synthesis of the first signal. From curves 5 and 6, it can be seen that the signal processing circuit 150, by performing frequency band synthesis of the sound pickup result signal and the first signal to obtain the composite signal, can make the background noise component in the composite signal closer to the background noise component in the original first signal, avoiding the background noise boost issue caused by the zero differential operation 41, thereby preventing noise disturbance to the user.

98. In some exemplary embodiments, in a scenario where the speaker module 110 comprises multiple speakers, when the sound emission frequency bands corresponding to different speakers are different, different zero differential schemes can be adopted for different frequency bands, so that the zero sound pickup direction of the sound sensor module 120 in different frequency bands points to the speaker corresponding to that frequency band, thereby minimizing the signal components from each speaker in the composite signal as much as possible. Take the example where the speaker module 110 comprises a first speaker 110-1 and a second speaker 110-2 for illustration. Assume that the sound emission frequency band of the first speaker 110-1 comprises the first sub-frequency band, and the sound emission frequency band of the second speaker 110-2 comprises the second sub-frequency band. In this case, the signal of the first sub-frequency band in the composite signal comes from the first sound pickup result signal obtained by the sound sensor module 120 in the first sound pickup state, where the first sound pickup state corresponds to the zero sound pickup direction of the sound sensor module 120 pointing to the first speaker 110-1. The signal of the second sub-frequency band in the composite signal comes from the second sound pickup result signal obtained by the sound sensor module 120 in the second sound pickup state, where the second sound pickup state corresponds to the zero sound pickup direction of the sound sensor module 120 pointing to the second speaker 120-2, and the sound pickup direction patterns corresponding to the first sound pickup state and the second sound pickup state are different. That is to say, when the signal processing circuit 150 adjusts the zero sound pickup direction, it can adopt different zero differential operations 41 for the first sub-frequency band and the second sub-frequency band, respectively, so that the sound pickup direction pattern corresponding to the first sub-frequency band is different from the sound pickup direction pattern corresponding to the second sub-frequency band. In practical applications, considering that each zero differential scheme may have different zero attenuation effects in different frequency bands (i.e., the sound intensity attenuation in the zero sound pickup direction), it is possible to refer to the zero attenuation performance of each zero differential operation 41 in different frequency bands and adopt the zero differential operation 41 with better zero attenuation effects for the first sub-frequency band and the second sub-frequency band respectively, thereby improving the overall zero attenuation effect across the entire frequency band.

99. FIG. 18 shows a schematic diagram of the zero attenuation effects corresponding to different zero differential operations according to some exemplary embodiments of the present disclosure. As shown in FIG. 18, curve 1 illustrates a frequency response diagram of the first signal collected by the first sound sensor 120-1. Taking the first sound sensor 120-1 as an omnidirectional sound sensor as an example, curve 1 characterizes the frequency response of the first signal in any pickup direction. Curve 2 illustrates a frequency response diagram of the sound pickup result signal in the zero sound pickup direction obtained using the zero differential operation 41a shown in FIG. 7 (corresponding to a cardioid sound pickup direction pattern). Curve 3 illustrates a frequency response diagram of the sound pickup result signal in the zero sound pickup direction obtained using the zero differential operation 41b shown in FIG. 10 (corresponding to a sound pickup direction pattern in the shape of the number “8”). As can be seen from FIG. 18, within the 1 kHz-4 KHz frequency band, the attenuation of curve 2 relative to curve 1 is greater than the attenuation of curve 3 relative to curve 1. This means that the zero differential operation 41a shown in FIG. 7 (corresponding to a cardioid sound pickup direction pattern) has a greater sound intensity attenuation in the zero sound pickup direction than the zero differential operation 41b shown in FIG. 10 (corresponding to a sound pickup direction pattern in the shape of the number “8”) in the zero sound pickup direction. Therefore, within the 1 kHz-4 KHz frequency band, the zero attenuation effect of the zero differential operation 41a shown in FIG. 7 (corresponding to a cardioid sound pickup direction pattern) is superior to that of the zero differential operation 41b shown in FIG. 10 (corresponding to a sound pickup direction pattern in the shape of the number “8”).

100. Continuing to refer to FIG. 18, within the 4 kHz-8 KHz frequency band, the attenuation of curve 3 relative to curve 1 is more pronounced than the attenuation of curve 2 relative to curve 1. This means that the zero differential operation 41b shown in FIG. 10 (corresponding to a sound pickup direction pattern in the shape of the number “8”) has a greater sound intensity attenuation in the zero sound pickup direction than the zero differential operation 41a shown in FIG. 7 (corresponding to a cardioid sound pickup direction pattern) in the zero sound pickup direction. Therefore, within the 4 kHz-8 KHz frequency band, the zero attenuation effect of the zero differential operation 41b shown in FIG. 10 (corresponding to a sound pickup direction pattern in the shape of the number “8”) is superior to that of the zero differential operation 41a shown in FIG. 7 (corresponding to a cardioid sound pickup direction pattern).

101. Based on the comparison of zero attenuation effects shown in FIG. 18, in some exemplary embodiments, the first frequency band can be divided into a first sub-frequency band and a second sub-frequency band, with the frequencies in the first sub-frequency band being lower than those in the second sub-frequency band. For example, the first sub-frequency band can be a mid-frequency band (e.g., 1 kHz-4 kHz as shown in FIG. 18), and the second sub-frequency band can be a high-frequency band (e.g., 4 kHz-8 kHz as shown in FIG. 18). In this case, for the first sub-frequency band, the zero differential operation 41a as shown in FIG. 7 can be adopted, where the sound pickup direction pattern corresponding to the sound sensor module 120 is cardioid; for the second sub-frequency band, the zero differential operation 41b as shown in FIG. 10 or the zero differential operation 41c as shown in FIG. 13 can be adopted, where the sound pickup direction pattern corresponding to the sound sensor module 120 is in the shape of the number “8”. As a result, both the first sub-frequency band and the second sub-frequency band exhibit significant attenuation in the zero sound pickup direction, thereby enhancing the overall zero attenuation effect.

102. FIG. 19 shows a schematic diagram of a signal processing process provided according to some exemplary embodiments of the present disclosure, applicable to the scenario where different zero differential operations are adopted for the first sub-frequency band and the second sub-frequency band, respectively. As shown in FIG. 19, assume that the speaker module 110 comprises a first speaker 110-1 and a second speaker 110-2, where the sound emission frequency band of the first speaker 110-1 comprises the first sub-frequency band, and the sound emission frequency band of the second speaker 110-2 comprises the second sub-frequency band. The zero differential operation 41 can comprise a first zero differential operation 41-1 and a second zero differential operation 41-2. Among them, the first zero differential operation 41-1 can adopt the zero differential operation 41a as shown in FIG. 7 (i.e., a single-delay zero differential scheme, corresponding to a cardioid sound pickup direction pattern), while the second zero differential operation 41-2 can adopt the zero differential operation 41b as shown in FIG. 10 or the zero differential operation 41c as shown in FIG. 13 (i.e., a dual-delay zero differential scheme, corresponding to a sound pickup direction pattern in the shape of the number “8”). After obtaining the first signal and the second signal, the signal processing circuit 150 can perform the first zero differential operation 41-1 on the first signal and the second signal to make the zero sound pickup direction of the sound sensor module 120 point to the first speaker 110-1, thereby obtaining the first sound pickup result signal, and perform the second zero differential operation 41-2 on the first signal and the second signal to make the zero sound pickup direction of the sound sensor module 120 point to the second speaker 110-2, thereby obtaining the second sound pickup result signal. Here, the first sound pickup result signal is a sound pickup result signal obtained based on a cardioid sound pickup direction pattern, while the second sound pickup result signal is a sound pickup result signal obtained based on a sound pickup direction pattern in the shape of the number “8”.

103. Continuing to refer to FIG. 19, the signal synthesis operation 42 may comprise: a first filtering operation 421, a second filtering operation 422, a third filtering operation 423, and a synthesis operation 424. Among them, the first filtering operation 421 is configured to perform first filtering on the first signal to obtain the component of the second frequency band in the first signal. For example, the second frequency band can be a low-frequency band (e.g., less than 1000 Hz), and in this case, the first filtering operation 421 can be implemented through a low-pass filter. The second filtering operation 422 is configured to perform second filtering on the first sound pickup result signal to obtain the component of the first sub-frequency band in the first sound pickup result signal. For example, the first sub-frequency band can be a high-frequency band (e.g., greater than 4 kHz), and in this case, the second filtering operation 422 can be implemented through a high-pass filter. The third filtering operation 423 is configured to perform third filtering on the second sound pickup result signal to obtain the component of the second sub-frequency band in the second sound pickup result signal. For example, the second sub-frequency band can be a mid-frequency band (e.g., 1 kHz-4 kHz), and the second filtering operation 422 can be implemented through a bandpass filter. The synthesis operation 424 is configured to synthesize the component of the second frequency band obtained from the first filtering operation 421, the component of the first sub-frequency band obtained from the second filtering operation 422, and the component of the second sub-frequency band obtained from the third filtering operation 423 to obtain a composite signal. In some exemplary embodiments, the synthesis operation 424 can be implemented using an adder. Continuing to refer to FIG. 19, after obtaining the composite signal, the signal processing circuit 150 can perform a gain amplification operation 51 on the composite signal to obtain a gain-amplified signal. Subsequently, based on the sound emission frequency bands of the first speaker 110-1 and the second speaker 110-2, a frequency division operation 52 is performed on the gain-amplified signal, and the divided signals are sent to the first speaker 110-1 and the second speaker 110-2, respectively. For example, assume that the sound emission frequency band of the first speaker 110-1 comprises the second frequency band and the first sub-frequency band, and the sound emission frequency band of the second speaker 110-2 comprises the second sub-frequency band. In this case, the frequency division operation 52 can extract a first target signal corresponding to the second frequency band and the first sub-frequency band from the gain-amplified signal, and extract a second target signal corresponding to the second sub-frequency band. Furthermore, the signal processing circuit 150 can send the first target signal to the first speaker 110-1 and the second target signal to the second speaker 110-2. The frequency division operation 52 can be implemented through filters or other feasible methods, and this disclosure does not impose any limitations on this.

104. It should be noted that, in the scenario where the speaker module 110 comprises the first speaker 110-1 and the second speaker 110-2, the signal processing process shown in FIG. 19 is only one possible example. In practical applications, after obtaining the first sound pickup result signal and the second sound pickup result signal, the signal processing circuit 150 may also adopt other signal processing methods. For example, in some exemplary embodiments, the signal processing circuit 150 may perform a first filtering operation 421 on the first signal to obtain the component of the second frequency band in the first signal, perform a second filtering operation 422 on the first sound pickup result signal to obtain the component of the first sub-frequency band in the first sound pickup result signal, and perform a third filtering operation 423 on the second sound pickup result signal to obtain the component of the second sub-frequency band in the second sound pickup result signal. Subsequently, the signal processing circuit synthesizes the component of the first sub-frequency band and the component of the second frequency band to obtain a first composite signal, performs a first gain amplification operation on the first composite signal and sends it to the first speaker 110-1, and performs a second gain amplification operation on the component of the second sub-frequency band and sends it to the second speaker 110-2.

105. Similar to what is shown in FIG. 15, the first filtering operation 421, the second filtering operation 422, and the third filtering operation 423 in FIG. 19 can be referred to as a set of complementary filters, in other words, the sum of the transfer function corresponding to the first filtering operation 421, the transfer function corresponding to the second filtering operation 422, and the transfer function corresponding to the third filtering operation 423 equals 1. For explanations and effects regarding complementary filters, refer to the relevant descriptions earlier, which will not be repeated herein.

106. In some exemplary embodiments, any one or more of the aforementioned first filtering operation 421, second filtering operation 422, third filtering operation 423, and synthesis operation 424 may be implemented by the processor 220 in the signal processing circuit 150. That is, the processor 220 executes an instruction set and performs one or more of the above operations according to the instructions in the instruction set. In some exemplary embodiments, the signal processing circuit 150 may comprise a first filtering circuit, and the aforementioned first filtering operation 421 may be implemented by the first filtering circuit. In some exemplary embodiments, the signal processing circuit 150 may comprise a second filtering circuit, and the aforementioned second filtering operation 422 may be implemented by the second filtering circuit. In some exemplary embodiments, the signal processing circuit 150 may comprise a third filtering circuit, and the aforementioned third filtering operation 423 may be implemented by the third filtering circuit. In some exemplary embodiments, the signal processing circuit 150 may comprise a synthesis circuit, and the aforementioned synthesis operation 424 may be implemented by the synthesis circuit.

107. In the aforementioned embodiments, when generating the composite signal, the signal processing circuit 150 first performs a zero differential operation 41 on the first signal and the second signal to obtain a sound pickup result signal, and then filters the sound pickup result signal and the first signal to extract the component of the first frequency band from the sound pickup result signal and the component of the second frequency band from the first signal, subsequently synthesizing the components of the two frequency bands to obtain the composite signal. In some exemplary embodiments, the signal processing circuit 150 may also swap the order of the zero differential operation 41 and the filtering. Specifically, taking the two-frequency-band synthesis scheme shown in FIG. 15 as an example for illustration, the signal processing circuit 150 can generate the composite signal in the following manner: perform first filtering on the first signal to obtain a first sub-signal corresponding to the first frequency band in the first signal, perform second filtering on the first signal to obtain a second sub-signal corresponding to the second frequency band in the first signal, and perform the first filtering on the second signal to obtain a third sub-signal corresponding to the first frequency band in the second signal; then, perform a zero differential operation on the first sub-signal and the third sub-signal to obtain a target sub-signal, and subsequently synthesize the second sub-signal with the target sub-signal to obtain the composite signal. It should be understood that the specific implementation methods of the aforementioned zero differential operation, filtering operation, and synthesis operation are the same or similar to those described earlier, and will not be repeated herein.

108. S340: Perform a second target operation on the composite signal.

109. After obtaining the composite signal, the signal processing circuit 150 can perform a second target operation 50 on the composite signal based on the requirements of the application scenario. In some exemplary embodiments, continuing to refer to FIGS. 15 and 19, the signal processing circuit 150 may also be connected to the speaker module 110. In this case, the second target operation 50 may comprise a gain amplification operation 51. After obtaining the composite signal, the signal processing circuit 150 can perform the gain amplification operation 51 to amplify the gain of the composite signal, and then send the gain-amplified signal to the speaker module 110 to enable the speaker module 110 to emit sound. The above scheme can be applied to the howling suppression scenario as shown in FIG. 1. It should be understood that since the composite signal has reduced signal components from the speaker module 110 (or in other words, the signal strength from the speaker module 110 is lowered), it disrupts the conditions for the sound emitted by the speaker module 110 to generate howling in the closed-loop circuit shown in FIG. 1, thereby achieving the effect of suppressing howling. In some exemplary embodiments, the aforementioned gain amplification operation 51 can be implemented by the processor 220 in the signal processing circuit 150, where the processor 220 executes an instruction set and performs the gain amplification operation 51 according to the instructions in the instruction set. In some exemplary embodiments, the signal processing circuit 150 may comprise a gain amplification circuit, and the aforementioned gain amplification operation 51 can be implemented through the gain amplification circuit.

110. In some exemplary embodiments, the speaker module 110, the sound sensor module 120, and the signal processing circuit 150 are integrated into a first acoustic device, and the first acoustic device is communicatively connected to a second acoustic device. In this case, the second target operation 50 may comprise: sending the composite signal to the second acoustic device to reduce the echo of the second acoustic device. The above scheme can be applied to the echo cancellation scenario as shown in FIG. 2. For example, the first acoustic device can be a local-end device, and the second acoustic device can be a remote-end device. Since the composite signal has reduced signal components from the speaker (or in other words, the signal strength from the speaker is lowered), it is equivalent to reducing the sound from the second acoustic device. Therefore, when the second acoustic device receives and plays the composite signal, the user on the second acoustic device side (i.e., the remote user) will not hear or will hear less echo, thereby achieving the effect of echo cancellation.

111. In summary, the present disclosure provides a signal processing method and an acoustic system. The method comprises: obtaining a first signal and a second signal, where the first signal is obtained by a first sound sensor in the sound sensor module collecting ambient sound while operating, and the second signal is obtained by a second sound sensor in the sound sensor module collecting ambient sound while operating, with the ambient sound including at least the target sound output by the speaker during operation; performing a first target operation on the first signal and the second signal to generate a composite signal; and performing a second target operation on the composite signal. The composite signal is a synthesized signal of a first frequency band signal and a second frequency band signal, where the first frequency band signal comes from a sound pickup result signal of the sound sensor module in a target sound pickup state, and the target sound pickup state corresponds to the zero sound pickup direction of the sound sensor module pointing to the speaker. In the above scheme, since the sound pickup result signal is obtained by the sound sensor module picking up sound when its zero sound pickup direction points to the speaker, the sound pickup result signal contains little or no signal components from the speaker. Furthermore, since the first frequency band in the composite signal comes from the sound pickup result signal, the signal components from the speaker in the composite signal are reduced. Therefore, the acoustic system can achieve the effect of suppressing howling or eliminating echo.

112. Another aspect of the present disclosure provides a non-transitory storage medium storing at least one set of executable instructions for performing signal processing. When the executable instructions are executed by a processor, the executable instructions guide the processor to implement the steps of the signal processing method P100 described in the present disclosure. In some possible implementations, various aspects of the present disclosure may also be realized in the form of a program product, which comprises program code. When the program product runs on an acoustic system 003, the program code is used to cause the acoustic system 003 to execute the steps of the signal processing method P100 described in the present disclosure. The program product for implementing the above method may use a portable compact disc read-only memory (CD-ROM) that comprises program code and can run on the acoustic system 003. However, the program product of the present disclosure is not limited to this. In the present disclosure, the readable storage medium can be any tangible medium that contains or stores a program, which can be used by or in combination with an instruction execution system. The program product may adopt any combination of one or more readable media. The readable medium may be a readable signal medium or a readable storage medium. The readable storage medium may be, for example, but not limited to, an electrical, magnetic, optical, electromagnetic, infrared, or semiconductor system, apparatus, or device, or any combination thereof. More specific examples of readable storage media comprise: an electrical connection with one or more wires, a portable disk, a hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination thereof. The computer-readable storage medium may comprise a data signal propagated in baseband or as part of a carrier wave, carrying readable program code. Such propagated data signals may take various forms, including but not limited to electromagnetic signals, optical signals, or any suitable combination thereof. The readable storage medium may also be any readable medium other than a readable storage medium that can send, propagate, or transmit a program for use by or in combination with an instruction execution system, apparatus, or device. The program code contained on the readable storage medium may be transmitted using any suitable medium, including but not limited to wireless, wired, optical cable, RF, etc., or any suitable combination thereof. The program code for performing the operations of the present disclosure may be written in any combination of one or more programming languages, including object-oriented programming languages—such as Java, C++, etc.—and conventional procedural programming languages—such as the “C” language or similar programming languages. The program code may execute entirely on the acoustic system 003, partially on the acoustic system 003, as a standalone software package, partially on the acoustic system 003 and partially on a remote computing device, or entirely on a remote computing device.

113. The above description pertains to specific embodiments of the present disclosure. Other embodiments are within the scope of the appended claims. In some cases, the actions or steps described in the claims can be performed in a sequence different from the one in the embodiments and still achieve the desired result. Additionally, the processes depicted in the drawings do not necessarily require a specific order or continuous sequence to achieve the desired outcome. In certain embodiments, multitasking and parallel processing are also possible or may be beneficial.

114. In summary, after reading this detailed disclosure, a person skilled in the art can understand that the aforementioned detailed disclosure is presented only by way of example and is not intended to be limiting. Although not explicitly stated here, a person skilled in the art will appreciate that the disclosure encompasses various reasonable alterations, improvements, and modifications to the embodiments. These alterations, improvements, and modifications are intended to be within the spirit and scope of the exemplary embodiments presented in this disclosure.

115. In addition, certain terms in this disclosure have been used to describe the embodiments of the disclosure. For example, the terms “an embodiment,” “embodiment,” and/or “some exemplary embodiments” mean that specific features, structures, or characteristics described in connection with that embodiment may be included in at least one embodiment of the disclosure. Therefore, it should be emphasized and understood that references to “embodiment,” “an embodiment,” or “alternative embodiment” in various parts of this disclosure do not necessarily refer to the same embodiment. Additionally, specific features, structures, or characteristics may be appropriately combined in one or more embodiments of the disclosure.

116. It should be understood that in the foregoing description of the embodiments of the disclosure, in order to aid in understanding a feature and simplify the presentation, various features are combined in a single embodiment, drawing, or description. However, this does not mean that the combination of these features is required. A person skilled in the art, upon reading this disclosure, could very well consider part of the equipment marked as a separate embodiment. In other words, the embodiments in this disclosure can also be understood as the integration of multiple sub-embodiments. And each sub-embodiment is valid even when it comprises fewer features than a single full embodiment disclosed above.

117. Each patent, patent disclosure, publication of a patent disclosure, and other materials, such as articles, books, specifications, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

118. Finally, it should be understood that the embodiments of the disclosure disclosed herein are illustrative of the principles of the embodiments of this disclosure. Other modified embodiments are also within the scope of this disclosure. Therefore, the embodiments disclosed in this disclosure are merely examples and not limitations. A person skilled in the art can adopt alternative configurations based on the embodiments in this disclosure to implement the disclosure. Thus, the embodiments of this disclosure are not limited to the embodiments described in the disclosure in precise detail.

What is claimed is:

1. An acoustic system, comprising:
a speaker module, configured to receive an input signal and output a target sound during operation;
a sound sensor module, comprising at least: a first sound sensor and a second sound sensor, wherein the first sound sensor collects an ambient sound and generates a first signal during operation, the second sound sensor collects the ambient sound and generates a second signal during operation, and the ambient sound comprises at least the target sound; and
a signal processing circuit, wherein the signal processing circuit is connected to the sound sensor module and configured to execute during operation:
obtaining a first signal,
obtaining a second signal,
performing a first target operation on the first signal and the second signal to generate a composite signal, wherein the composite signal is a synthesized signal of a signal in a first frequency band and a signal in a second frequency band, the signal in the first frequency band is derived from a sound pickup result signal of the sound sensor module in a target sound pickup state, the target sound pickup state corresponds to a zero sound pickup direction of the sound sensor module pointing toward the speaker module, and
performing a second target operation on the composite signal.

2. The acoustic system according to claim 1, wherein the signal in the second frequency band is derived from the first signal.

3. The acoustic system according to claim 2, wherein the first target operation comprises:
a zero differential operation, to perform a zero differential on the first signal and the second signal so as to adjust the zero sound pickup direction of the sound sensor module to point toward the speaker module, thereby obtaining the sound pickup result signal; and
a signal synthesis operation, to synthesize a component of the first frequency band from the sound pickup result signal with a component of the second frequency band from the first signal to obtain the composite signal.

4. The acoustic system according to claim 3, wherein the zero differential operation comprises:
a first delay operation, to delay the second signal to obtain a second delayed signal;
a first differential operation, to perform a differential operation on the first signal and the second delayed signal to obtain a first differential signal; and
a gain compensation operation, to perform gain compensation on a signal of at least partial frequency band in the first differential signal to obtain the sound pickup result signal.

5. The acoustic system according to claim 3, wherein the zero differential operation comprises:
a first delay operation, to delay the second signal to obtain a second delayed signal;
a second delay operation, to delay the first signal to obtain a first delayed signal;
a first differential operation, to perform a differential operation on the first signal and the second delayed signal to obtain a first differential signal;
a second differential operation, to perform a differential operation on the second signal and the first delayed signal to obtain a second differential signal;
a third differential operation, to perform a differential operation on the first differential signal and the second differential signal to obtain a third differential signal; and
a gain compensation operation, to perform gain compensation on a signal of at least partial frequency band in the third differential signal to obtain the sound pickup result signal.

6. The acoustic system according to claim 5, wherein the zero differential operation further comprises:
a target parameter generation operation, to generate a target parameter with a goal of minimizing a signal component corresponding to the target sound in the third differential signal; and
a multiplication operation performed between the second differential operation and the third differential operation by multiplying the target parameter with the second differential signal to obtain a multiplication result, so that the third differential operation performs a differential operation on the first differential signal and the multiplication result to obtain the third differential signal.

7. The acoustic system according to claim 3, wherein the signal synthesis operation comprises:
performing a first filtering on the first signal to obtain the component of the second frequency band in the first signal;
performing a second filtering on the sound pickup result signal to obtain the component of the first frequency band in the sound pickup result signal; and
synthesizing the component of the first frequency band with the component of the second frequency band to obtain the composite signal.

8. The acoustic system according to claim 7, wherein the first filtering and the second filtering are complementary filtering.

9. The acoustic system according to claim 2, wherein the first target operation comprises:
performing a first filtering on the first signal to obtain a first sub-signal corresponding to the first frequency band in the first signal, and performing a second filtering on the first signal to obtain a second sub-signal corresponding to the second frequency band in the first signal;
performing the first filtering on the second signal to obtain a third sub-signal corresponding to the first frequency band in the second signal;
performing a zero differential operation on the first sub-signal and the third sub-signal to obtain a target sub-signal; and
synthesizing the second sub-signal with the target sub-signal to obtain the composite signal.

10. The acoustic system according to claim 2, wherein a phase of a signal component corresponding to the target sound in the second signal is earlier than or equal to a phase of a signal component corresponding to the target sound in the first signal.

11. The acoustic system according to claim 2, wherein a frequency in the first frequency band is higher than a frequency in the second frequency band.

12. The acoustic system according to claim 2, wherein the second frequency band comprises a frequency band corresponding to a background noise of a current environment, and the first frequency band comprises a frequency band other than the second frequency band.

13. The acoustic system according to claim 12, wherein the signal processing circuit is further configured to execute during operation:
determining a background noise feature corresponding to the current environment based on the first signal and the second signal; and
determining a frequency range corresponding to the first frequency band and a frequency range corresponding to the second frequency band based on the background noise feature.

14. The acoustic system according to claim 1, wherein the speaker module comprises a first speaker and a second speaker, the first frequency band comprises a first sub-frequency band and a second sub-frequency band, a sound emission frequency band of the first speaker comprises the first sub-frequency band, a sound emission frequency band of the second speaker comprises the second sub-frequency band;
a signal of the first sub-frequency band in the composite signal is derived from a first sound pickup result signal obtained by the sound sensor module in a first sound pickup state, the first sound pickup state corresponds to the zero sound pickup direction of the sound sensor module pointing toward the first speaker; and
a signal of the second sub-frequency band in the composite signal is derived from a second sound pickup result signal obtained by the sound sensor module in a second sound pickup state, the second sound pickup state corresponds to the zero sound pickup direction of the sound sensor module pointing toward the second speaker, wherein a sound pickup direction pattern corresponding to the first sound pickup state is different from a sound pickup direction pattern corresponding to the second sound pickup state.

15. The acoustic system according to claim 14, wherein a frequency in the first sub-frequency band is lower than a frequency in the second sub-frequency band; and
the sound pickup direction pattern corresponding to the first sound pickup state is cardioid, and the sound pickup direction pattern corresponding to the second sound pickup state is in a shape of number “8”.

16. The acoustic system according to claim 1, wherein the second target operation comprises: performing gain amplification on the composite signal and sending a gain-amplified signal to the speaker module, so that the speaker module emits a sound.

17. The acoustic system according to claim 1, wherein the speaker module and the sound sensor module are arranged on a first acoustic device, and the first acoustic device is in communication with a second acoustic device; and
the second target operation comprises: sending the composite signal to the second acoustic device to reduce an echo of the second acoustic device.

18. The acoustic system according to claim 1, wherein the acoustic system is any one of a hearing aid system, a sound amplification system, a headphone system, a telephone system, or a conference system.

19. The acoustic system according to claim 1, wherein the acoustic system is a hearing aid system and further comprises a housing, and the speaker module, the sound sensor module and the signal processing circuit are disposed within the housing, wherein
when the acoustic system is worn on a user's head, a sound output end of the speaker module faces the user's head, and a sound pickup end of at least one sound sensor in the sound sensor module is located on a side of the housing away from the user's head.

20. A signal processing method, comprising:
obtaining a first signal, wherein the first signal is obtained by a first sound sensor in a sound sensor module during operation to capture an ambient sound, the ambient sound at least comprises a target sound, and the target sound is a sound output by a speaker module during operation;
obtaining a second signal, wherein the second signal is obtained by a second sound sensor in the sound sensor module during operation to capture the ambient sound;
performing a first target operation on the first signal and the second signal to generate a composite signal, wherein the composite signal is a synthesized signal of a signal in a first frequency band and a signal in a second frequency band, the signal in the first frequency band is derived from a sound pickup result signal of the sound sensor module in a target sound pickup state, the target sound pickup state corresponds to a zero sound pickup direction of the sound sensor module pointing toward the speaker module; and
performing a second target operation on the composite signal.
